(19) United States
(12) Patent Application Publication
(10) Pub. No.: US 2026/0121302 A1
(43) Pub. Date: Apr. 30, 2026

(54) COMMUNICATION DEVICE

(71) Applicant: RUIJIE NETWORKS CO., LTD., Fujian (CN)

(72) Inventors: Huishan XU, Fujian (CN); Xiaofeng WANG, Fujian (CN); Qijian WU, Fujian (CN); Xing YE, Fujian (CN)

(73) Assignee: RUIJIE NETWORKS CO., LTD., Fujian (CN)

(21) Appl. No.: 19/426,086

(22) Filed: Dec. 19, 2025

Related U.S. Application Data
(63) Continuation of application No. PCT/CN2023/143678, filed on Dec. 29, 2023.

(51) Int. Cl. H01Q 19/13; H01P 1/18; H01Q 9/16; H01Q 15/24; H01Q 19/00

(52) U.S. Cl. CPC H01Q 19/134; H01Q 9/16; H01Q 15/24; H01Q 19/005; H01P 1/18

(57) ABSTRACT

The present application discloses a communication device, where the communication device includes an antenna and a communication apparatus. The antenna includes a feed and a wiring board, the feed including a dipole unit. The dipole unit includes a first dipole and a second dipole, the second dipole being formed on one side of the wiring board. The communication apparatus includes a circuit board. The first dipole is formed on a surface of the circuit board. The circuit board is provided with a first slot. The wiring board extends through at least a portion of the first slot and connected to the circuit board. Both the first dipole and the second dipole are electrically connected to the circuit board.

### CROSS-REFERENCE TO RELATED APPLICATION

This application is a continuation of International Application of PCT application serial no. PCT/CN2023/143678 filed on Dec. 29, 2023 and entitled “COMMUNICATION DEVICE”. The entirety of the above-mentioned patent application is hereby incorporated by reference herein and made a part of this specification.

### BACKGROUND

### Technical Field

The present application relates to the field of wireless communication technology, and more particularly, to a communication device.

### Description of Related Art

A parabolic antenna is a high-gain antenna widely used in long-range communication systems such as radar, satellite, and mobile communication.

Currently, when assembling a parabolic antenna with a communication apparatus, the communication apparatus needs to be connected to the antenna output port of the parabolic antenna through an external feedline. Moreover, a feedline is also required to connect the antenna feed with the antenna output port of the parabolic antenna.

### SUMMARY

Embodiments of the present application provide a communication device.

According to a first aspect, an embodiment of the present application provides a communication device, where the communication device includes:
an antenna including a feed and a wiring board, the feed including a dipole unit and the dipole unit including a first dipole and a second dipole, where the second dipole is formed on a surface of the wiring board; and
a communication apparatus including a circuit board, the first dipole being formed on a surface of the circuit board; where the circuit board is provided with a first slot, the wiring board extends through at least a portion of the first slot and connected to the circuit board; and the first dipole and the second dipole are both electrically connected to the circuit board.

In the communication device of the present application, the first dipole of the feed of the antenna is integrated on the circuit board of the communication apparatus, and the second dipole of the feed is integrated on the wiring board. In this way, after the wiring board is assembled to the circuit board and connected thereto, both the first dipole and the second dipole may be electrically connected to the circuit board, achieving electrical connection between the antenna and the communication apparatus while providing the communication device with a high degree of integration. When the communication device of the present application is installed at a construction site, there is no need for the communication apparatus to be connected to the antenna output port of the antenna via an external feedline, nor is there a need to connect the feed to the antenna output port of the antenna. This not only simplifies the assembly process of the antenna and the communication apparatus, reducing the construction cost of installing the communication device, but also prevents signal attenuation during transmission between the communication apparatus and the first dipole, as well as between the communication apparatus and the second dipole, thereby improving the gain of the antenna, enhancing the signal quality of the communication apparatus, and improving the coverage performance and coverage distance of the communication apparatus, which facilitates long-range wireless communication. Additionally, the first dipole and the second dipole may form dual-channel signal ports of the antenna.

In some embodiments, the wiring board has a long side and a short side, and when the wiring board extends through the first slot, the long side intersects with the surface of the circuit board and is connected to the circuit board and the short side is located at a side of the circuit board; and
the second dipole is disposed on a side of the wiring board adjacent to the long side, so that the second dipole may be electrically connected to the circuit board, enabling signal transmission and reception functions of the antenna at the second dipole.

In some embodiments, the feed comprises orthogonal dual-polarized dipoles, the first dipole being a vertically polarized dipole of the orthogonal dual-polarized dipoles, and the second dipole being a horizontally polarized dipole of the orthogonal dual-polarized dipoles.

In this way, the antenna may receive and transmit signals along the electric field direction of the first dipole and the electric field direction of the second dipole.

In some embodiments, a length of the first slot is greater than a length of the short side, and a slot width of the first slot is greater than a thickness of the wiring board, so as to enable assembly of the wiring board on the circuit board; and
the long side is disposed perpendicular to the surface of the circuit board, and the short side is disposed parallel to the surface of the circuit board, so that the second dipole may form orthogonal dual-polarized dipoles with the first dipole.

In some embodiments, the first dipole includes two first radiating arms, the two first radiating arms being formed on two surfaces of the circuit board in a thickness direction, so that one of the two first radiating arms is electrically connected to a radio frequency port of the circuit board, and the other of the two first radiating arms may be grounded on the circuit board; the two first radiating arms are distributed symmetrically about a center on two sides of the first slot.

In some embodiments, the second dipole includes two second radiating arms, the two second radiating arms being formed on a same surface of the wiring board, or the two second radiating arms being formed on two surfaces of the wiring board in a thickness direction, so that one of the two second radiating arms may be electrically connected to the radio frequency port of the circuit board, and the other of the two second radiating arms may be grounded on the circuit board while allowing for more diverse placement positions of the second radiating arms.

In some embodiments, the first radiating arm includes a fan-shaped microstrip, and in a direction in which the two first radiating arms extend away from each other, a width of the fan-shaped microstrip gradually increases to increase a bandwidth of the antenna at the first dipole; a direction of the width of the fan-shaped microstrip being parallel to the short side.

In some embodiments, the two first radiating arms are centrally symmetric to each other, the two first radiating arms being distributed on two sides of the first slot; and/or the two second radiating arms are centrally symmetric to each other, the two second radiating arms being disposed on two sides of the wiring board. In this way, both the first dipole and the second dipole are configured as centrally symmetric structures. When the wiring board extends through the first slot, the two second radiating arms may be distributed on two sides of the first dipole, so that the dipole unit may form orthogonal dual-polarized dipoles.

In some embodiments, the feed further includes first transmission lines and second transmission lines, each of the two first radiating arms corresponding to one first transmission line; and one of the two first radiating arms is electrically connected to the radio frequency port on the circuit board through the corresponding first transmission line, and the other is grounded through the corresponding first transmission line, so that the two first radiating arms form radiation; and each of the two second radiating arms corresponds to one second transmission line; one of the two second radiating arms is electrically connected to the radio frequency port through the corresponding second transmission line, and the other is grounded through the corresponding second transmission line, so that the two second radiating arms form radiation.

In some embodiments, both the first transmission line and the second transmission line are formed on the circuit board to enable fixation of the first transmission line and the second transmission line.

In some embodiments, the feed further includes a balun structure, the balun structure being located on the circuit board and electrically connected to the radio frequency port;
each of the two first radiating arms is electrically connected to the balun structure through one first transmission line to form radiation while enabling electrical connection of the first radiating arms to the radio frequency port through the balun structure; and each of the two second radiating arms is electrically connected to the balun structure through one second transmission line to form radiation while enabling electrical connection of the second radiating arms to the radio frequency port through the balun structure; and
the balun structure is configured to achieve a 180° phase shift, so that currents in the two first radiating arms flow in a same direction, and currents in the two second radiating arms flow in a same direction.

In this way, while one of the two first radiating arms radiates externally, the other of the two first radiating arms may be grounded, thereby achieving radiation and grounding of the first dipole. Additionally, the balun structure ensures that currents in the two first transmission lines flow in opposite directions, preventing radiation.

Moreover, since the two first radiating arms are formed on two surfaces of the circuit board, it is possible to prevent one of the two first transmission lines from being covered by the other on the same side of the circuit board, ensuring normal radiation and grounding of the two first radiating arms.

In some embodiments, the balun structure includes a first microstrip balun and a second microstrip balun, the first microstrip balun being located on a surface of the circuit board provided with the radio frequency port, and the second microstrip balun being located on a surface of the circuit board opposite to the first microstrip balun and grounded;
one of the two first radiating arms is electrically connected to the first microstrip balun through the corresponding first transmission line, and the other is electrically connected to the second microstrip balun through the corresponding first transmission line, thereby achieving radiation and grounding of the first dipole; and
one of the two second radiating arms is electrically connected to the first microstrip balun through the corresponding second transmission line, and the other is electrically connected to the second microstrip balun through the corresponding second transmission line, thereby achieving radiation and grounding of the second dipole.

In some embodiments, when the wiring board extends through at least a portion of the first slot, the wiring board intersects with the circuit board and is connected through a plurality of connection portions; the connection portions being distributed on a same surface of the circuit board, so that the wiring board may be fixed on the circuit board through the connection portions while completing the connection between the wiring board and the circuit board on the same surface of the circuit board, without the need to flip the circuit board.

In some embodiments, the first slot is located in a middle region of the circuit board. This may prevent detachment of the connection portions (for example, solder joints) when two sides of the circuit board in the length direction of the first slot are subjected to compression, thereby enhancing the stability of the connection between the wiring board and the circuit board.

In some embodiments, a distance between the first slot and a top edge of the circuit board is greater than or equal to 3 mm and less than or equal to 10 mm, to further enhance the stability of the connection portions.

In some embodiments, the antenna includes a parabolic antenna, the parabolic antenna further including a first reflector, a reflective surface of the first reflector being a paraboloid, and the circuit board being located within a reflection region of the reflective surface, so that the communication apparatus is integrated within the antenna while enabling the antenna to have the high-gain characteristics of a parabolic antenna.

In some embodiments, the first dipole and the second dipole are spaced apart along a line connecting a focus of the paraboloid and a center of the paraboloid, with the second dipole located below the first dipole, to prevent signal interference due to overlapping of the first dipole and the second dipole, ensuring the performance of the antenna and the electrical performance of the communication device.

In some embodiments, the first dipole is located at the focus of the paraboloid to ensure that the position of the first dipole meets the design requirements of the parabolic antenna for dipoles.

In some embodiments, a distance between the first dipole and the second dipole along the line is greater than or equal to one-ninth of a wavelength of a center frequency of the parabolic antenna and less than or equal to one-sixth of the wavelength of the center frequency of the parabolic antenna. This effectively prevents signal interference between the first dipole and the second dipole while avoiding a reduction in the gain of the second dipole.

In some embodiments, a direction of the length of the first slot is parallel to the line and a short side of the wiring board and the wiring board is provided with a second slot on a side where the second dipole is disposed, the second dipole being disposed adjacent to a slot opening side of the second slot; and
when the wiring board extends through the first slot, a portion of the wiring board is inserted into the first slot and rests on a slot wall of the first slot, with the second slot located below the first slot, so that the second dipole is spaced apart below the first dipole along the line connecting the focus and the center of the paraboloid.

In some embodiments, the communication device further includes a microstrip parasitic unit, where the microstrip parasitic unit is located on a side of the dipole unit away from the communication apparatus and configured to enhance a gain of the second dipole. The provision of the microstrip parasitic unit helps reduce a gain difference and angular fluctuation between the first dipole and the second dipole, thereby reducing the time required for engineering alignment and improving the installation efficiency of the communication device.

In some embodiments, the microstrip parasitic unit includes a first microstrip unit and a second microstrip unit, each of the first microstrip unit and the second microstrip unit including two microstrips;
the two microstrips of the first microstrip unit are symmetrically disposed on the circuit board, and the two microstrips of the second microstrip unit are symmetrically disposed on the wiring board; and
when the wiring board extends through at least a portion of the first slot, the two microstrips of the first microstrip unit are connected to the two microstrips of the second microstrip unit to form the microstrip parasitic unit, so as to reduce a gain difference between the first dipole and the second dipole through the microstrip parasitic unit.

In some embodiments, a distance between a microstrip of the microstrip parasitic unit and the second radiating arm is one-quarter of a wavelength of a center frequency of the parabolic antenna, to ensure that an effect of the microstrip parasitic unit on enhancing the gain of the second dipole is greater than an effect on enhancing the gain of the first dipole.

In some embodiments, the antenna further includes a second reflector, the second reflector being mounted on an end of the circuit board away from the first reflector, the second reflector covering the dipole unit. In this way, the second reflector may reflect signals that have been reflected by the first reflector again, further increasing the gain of the dipole unit at the first dipole and the second dipole.

In some embodiments, the communication device further includes a housing, the circuit board being located within the housing to prevent the circuit board, the wiring board, and the second reflector from being exposed on a surface of the communication device; and/or, the first reflector has a plurality of through holes, the through holes being distributed on the reflective surface of the first reflector to improve a wind resistance rating and aesthetics of the antenna.

In some embodiments, the parabolic antenna further includes a mounting base and a clamp, the mounting base being mounted on a side of the first reflector away from the feed;
the mounting base has two intersecting recesses, shapes of the two recesses being adapted to a shape of a circumferential outer wall of a fixing rod, with an end of the recess in a length direction extending to a side wall of the mounting base and forming a notch on the side wall of the mounting base; the length direction of the recess is parallel to a length direction of the fixed fixing rod, so that while the mounting base of the parabolic antenna is fixed on the fixing rod, the fixing rod may be fixed at the recesses, and the recesses may limit the assembly of the mounting base on the fixing rod; and
the clamp is detachably mounted on the mounting base, and is selectively positioned at either of the two recesses to fix the mounting base on the fixing rod. By changing a position of the clamp on the two mounting bases, the parabolic antenna may be fixed on a horizontal rod or a vertical rod of the fixing rod, enabling the communication device to adapt to different installation sites.

In some embodiments, the parabolic antenna further includes a connection base, the connection base being mounted on the first reflector and located between the first reflector and the mounting base; and the connection base has a connection shaft; and
the mounting base has a sleeve portion, the sleeve portion being sleeved on a circumferential outer side of the connection shaft and connected to the connection shaft; and the connection shaft is rotatably disposed relative to the sleeve portion.

Through rotation of the connection shaft relative to the sleeve portion, an angle of the connection base relative to the mounting base may be adjusted, thereby adjusting a horizontal installation angle of the communication device during installation to facilitate alignment of the communication device during construction.

In some embodiments, the first reflector has a fixing seat, the connection base having a connection arm and the connection arm being disposed on a side of the fixing seat and rotatably connected to the fixing seat.

Through rotation of the fixing seat relative to the connection arm, a pitch angle of the communication device during installation may be adjusted to facilitate alignment of the communication device during construction.

According to a second aspect, an embodiment of the present application further provides a communication device, where the communication device includes a parabolic antenna, the parabolic antenna including a feed, a first reflector, a mounting base, and a clamp, a reflective surface of the first reflector being a paraboloid, the feed being located within a reflection region of the reflective surface of the first reflector; the mounting base being mounted on a side of the first reflector away from the feed; the mounting base having a first recess and a second recess that intersect, shapes of the first recess and the second recess being adapted to a shape of a circumferential outer wall of a fixing rod, with an end of the recess extending along an axial direction of the fixing rod; and the clamp being detachably mounted on the mounting base, the clamp being selectively positioned at either the first recess or the second recess to fix the mounting base on the fixing rod; and
an end of each of the first recess and the second recess in a length direction extends to a side wall of the mounting base and forms a notch on the side wall of the mounting base, the length direction of each of the first recess and the second recess being parallel to a length direction of the fixed fixing rod.

In the communication device of the present application, by changing a position of the clamp on the two mounting bases, the parabolic antenna may be fixed on a horizontal rod or a vertical rod of the fixing rod, enabling the communication device to adapt to different installation sites. Additionally, with the provision of the first recess and the second recess, while the mounting base of the parabolic antenna is fixed on the fixing rod, the fixing rod may be fixed at the first recess or the second recess, and the first recess or the second recess may limit the assembly of the mounting base on the fixing rod.

In some embodiments, the first recess and the second recess are perpendicularly disposed on the mounting base, and two clamps may be spaced apart along an extension direction of the recess in which they are located, so that both clamps encircle the horizontal rod or the vertical rod, enabling the horizontal rod or the vertical rod of the fixing rod to be fixed within one of the first recess and the second recess.

In some embodiments, the mounting base may have a through hole, and the clamp may be inserted into the through hole to achieve detachable connection of the clamp on the mounting base.

In some embodiments, the parabolic antenna further includes a connection base, the connection base being mounted on the first reflector and located between the first reflector and the mounting base; and the connection base having a connection shaft; and
the mounting base having a sleeve portion, the sleeve portion being sleeved on a circumferential outer side of the connection shaft and connected to the connection shaft; and the connection shaft being rotatably disposed relative to the sleeve portion.

Through rotation of the connection shaft relative to the sleeve portion, an angle of the connection base relative to the mounting base may be adjusted, thereby adjusting a horizontal installation angle of the communication device during installation to facilitate alignment of the communication device during construction.

In some embodiments, the connection base is further equipped with a first connection member, the connection shaft having a first connection hole; and the first connection member may be inserted into the first connection hole and fixed to the sleeve portion to achieve connection between the sleeve portion and the connection shaft.

In some embodiments, the connection base is further provided with a first knob, the first knob being located on a side of the connection base away from the mounting base; and the first knob having a second connection hole; where the first connection member may be sequentially inserted into the second connection hole and the first connection hole and fixed to the sleeve portion.

Through the first knob, a horizontal installation angle of the communication device may be adjusted.

In some embodiments, the connection base has engagement teeth on a side provided with the connection shaft, and the sleeve portion has engagement teeth on a side facing the connection base; when the connection shaft is assembled in the sleeve portion, the engagement teeth on the connection base engage with the engagement teeth on the sleeve portion, increasing friction between the connection base and the sleeve portion in a rotation direction of the connection shaft during rotation of the connection base relative to the sleeve portion, to ensure that an angle of the connection base relative to the sleeve portion remains fixed.

In some embodiments, the first reflector has a fixing seat, the connection base having a connection arm, and the connection arm being disposed on a side of the fixing seat and rotatably connected to the fixing seat.

Through rotation of the fixing seat relative to the connection arm, a pitch angle of the communication device during installation may be adjusted to facilitate alignment of the communication device during construction.

In some embodiments, the number of connection arms is two; the two connection arms are distributed on opposite sides of the fixing seat and are both rotatably connected to the fixing seat.

Through the provision of two connection arms, the stability of the connection between the connection base and the fixing seat may be enhanced, while also improving the stability of the rotation of the fixing seat relative to the connection arms.

In some embodiments, the fixing seat is further equipped with a second connection member; each connection arm has a fourth connection hole, the fourth connection hole being an arc-shaped hole; the fixing seat has a fifth connection hole; the second connection member is inserted into the fifth connection hole and the two fourth connection holes and fixed to the connection arms to achieve further connection between the connection base and the fixing seat.

In some embodiments, the parabolic antenna further includes a second knob, the second knob being located on a side of the connection base away from the fixing seat and the second knob having a sixth connection hole; where the second connection member may be inserted into the sixth connection hole, the fifth connection hole, and the two fourth connection holes and fixed to the connection arms.

By rotating the second knob, a pitch angle of the communication device during installation may be adjusted to facilitate alignment of the communication device during construction.

### BRIEF DESCRIPTION OF THE DRAWINGS

To more clearly illustrate the technical solutions in the embodiments of the present application or in the conventional technology, the drawings required for describing the embodiments or the conventional technology are briefly introduced below. It is apparent that the drawings described below are merely some embodiments of the present application, and those of ordinary skill in the art may obtain other drawings based on the structures shown in these drawings without creative effort.

FIG. 1 shows a schematic diagram of a transmission principle of a parabolic antenna;

FIG. 2 shows a schematic diagram of a focal length to aperture ratio of an antenna;

FIG. 3 shows a schematic diagram of a partial structure of a communication device provided by the present application;

FIG. 4 shows a first schematic diagram of the assembly of a wiring board on a circuit board in FIG. 3;

FIG. 5 shows a second schematic diagram of the assembly of a wiring board on a circuit board in FIG. 3;

FIG. 6 shows a third schematic diagram of the assembly of a wiring board on a circuit board in FIG. 3;

FIG. 7 shows a fourth schematic diagram of the assembly of a wiring board on a circuit board in FIG. 3;

FIG. 8 shows an enlarged view at A in FIG. 6;

FIG. 9 shows a fifth schematic diagram of the assembly of a wiring board on a circuit board in FIG. 3;

FIG. 10 shows a sixth schematic diagram of the assembly of a wiring board on a circuit board in FIG. 3;

FIG. 11 shows a gain pattern at a first dipole of a communication device provided by the present application without a microstrip parasitic unit;

FIG. 12 shows a gain pattern at a first dipole of a communication device provided by the present application with a microstrip parasitic unit;

FIG. 13 shows a gain pattern at a second dipole of a communication device provided by the present application without a microstrip parasitic unit;

FIG. 14 shows a gain pattern at a second dipole of a communication device provided by the present application with a microstrip parasitic unit;

FIG. 15 shows a schematic structural diagram of a communication device provided by the present application;

FIG. 16 shows a schematic structural diagram of another communication device provided by the present application;

FIG. 17 shows a schematic structural diagram of the communication device in FIG. 16 from another perspective;

FIG. 18 shows a schematic diagram of one installation of the communication device in FIG. 16;

FIG. 19 shows a schematic diagram of another installation of the communication device in FIG. 16;

FIG. 20 shows an exploded view of the communication device in FIG. 19 at a mounting base from a first perspective;

FIG. 21 shows an exploded view of the communication device in FIG. 19 at a mounting base from a second perspective;

FIG. 22 shows a schematic structural diagram of the communication device in FIG. 19 at a connection base; and

FIG. 23 shows an exploded view of the communication device in FIG. 22 at a connection base.

Reference signs: 100, feed; 110, first dipole; 111, first radiating arm; 120, second dipole; 121, second radiating arm; 130, balun structure; 131, first microstrip balun; 132, second microstrip balun; 140, first transmission line; 150, second transmission line; 160, tapered transmission line; 200, wiring board; 210, long side; 220, short side;
300, circuit board; 310, first slot; 320, radio frequency port; 330, connection portion; 340, extension portion;
400, first reflector; 410, arc-shaped structure; 411, through hole; 420, fixing seat; 421, circular protrusion;
430, connection base; 431, connection shaft; 4311, first connection hole; 432, connection arm; 4321, third connection hole; 4322, fourth connection hole; 4323, scale; 433, engagement teeth;
440, first knob; 441, second connection hole; 450, first connection member; 451, first connection head; 460, second connection member; 461, second connection head; 470, second knob; 471, sixth connection hole; 480, housing; 490, second locking member;
500, microstrip parasitic unit; 510, first microstrip unit; 511, solder pad; 520, second microstrip unit; 530, first microstrip; 540, second microstrip;
600, second reflector;
700, mounting base; 710, recess; 720, through hole; 730, sleeve portion; 731, assembly hole;
800, clamp; and
900, fixing rod.

### DESCRIPTION OF THE EMBODIMENTS

To make the objectives, technical solutions, and advantages of the embodiments of the present application clearer, the technical solutions in the embodiments of the present application are clearly and thoroughly described below in conjunction with the drawings in the embodiments of the present application. It is apparent that the described embodiments are some, but not all, embodiments of the present application. Based on the embodiments in the present application, all other embodiments obtained by those of ordinary skill in the art without creative effort fall within the scope of protection of the present application.

The terms used in the embodiments of the present application are solely for the purpose of describing specific embodiments and are not intended to limit the present application.

For ease of understanding, relevant technical terms involved in the embodiments of the present application are first explained and described.

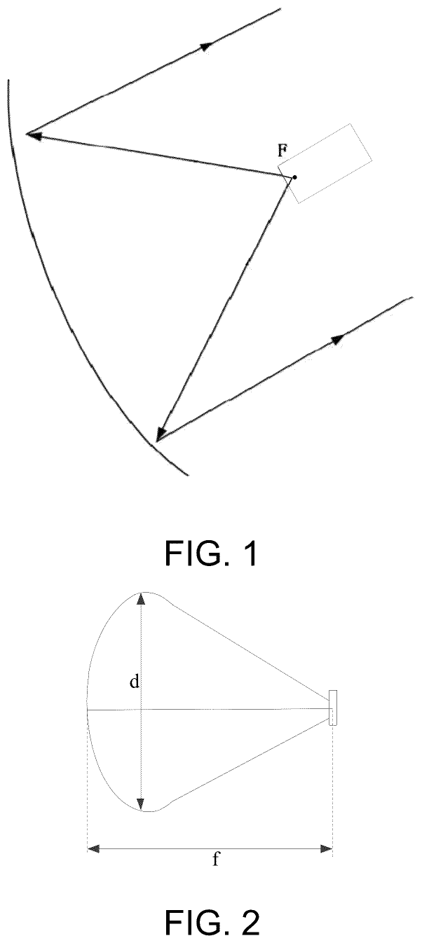

A parabolic antenna refers to a surface antenna composed of a parabolic reflector and a feed located at its focus F. The parabolic reflector refers to a reflector with a parabolic reflective surface. Referring to FIG. 1, during transmission, signals radiate from the feed toward the parabolic surface of the reflector and are radiated into the air after reflection by the parabolic surface. Since the feed is located at the focus F of the parabolic surface, electromagnetic waves, after reflection by the parabolic surface, radiate parallel to the normal of the parabolic surface. During reception, electromagnetic waves are reflected by the reflective surface and converge at the feed, where the feed may receive the maximum signal energy.

Gain refers to the ratio of the signal strength produced by an actual antenna to the signal strength produced by an ideal non-directional radiation point source at the same point in space under equal input power conditions. Antenna gain is used to measure the ability of an antenna to transmit and receive signals in a specific direction and is one of the important parameters for selecting a base station antenna. Gain is closely related to antenna directivity; the higher the antenna gain, the narrower the main lobe in the radiation pattern of the antenna, the better the directivity, and the more concentrated the energy.

The radiation pattern of an antenna typically has two or more lobes, with the lobe having the maximum radiation intensity called the main lobe and the remaining lobes called side lobes.

The focal length to aperture ratio of an antenna, also referred to as the focal-aperture ratio, may be expressed as f/d, as shown in FIG. 2. For a parabolic antenna, f refers to the focal length of the parabolic surface, and d is the aperture diameter of the parabolic surface projected on a plane perpendicular to the axis.

A parabolic antenna may form a high-gain and highly directional beam, giving the parabolic antenna characteristics of high gain and strong directivity. Parabolic antennas have several advantages in communication systems. First, due to the high-gain characteristics of parabolic antennas, they may provide stronger signals and longer transmission distances. Second, the beam-focusing characteristics of parabolic antennas may reduce multipath interference and background noise, thereby improving communication quality and reliability. Therefore, parabolic antennas are an ideal choice for long-range wireless communication systems and are widely used in radar, satellite, and mobile communication systems. For example, the transmission distance in long-range wireless communication systems may be greater than or equal to 8 kilometers and less than or equal to 15 kilometers.

Currently, when assembling the feed of a conventional parabolic antenna with a communication apparatus, the communication apparatus needs to be connected to the antenna output port of the parabolic antenna through an external feedline, and the feed also needs to be connected to the antenna output port of the parabolic antenna through an external feedline. The communication apparatus may include a bridge device. The bridge device may include wireless network devices such as a micro base station, a Wi-Fi bridge, an Ethernet bridge, or a bridging router. Due to the connection of the two external feedlines mentioned above, during engineering construction, not only is a connection process required between the communication apparatus and the antenna output port of the parabolic antenna, but an additional connection process between the feed and the antenna output port is also needed, making the assembly of the parabolic antenna and the communication apparatus cumbersome and increasing the construction cost during assembly.

Due to the presence of the two external feedlines mentioned above, signal loss increases during transmission between the communication apparatus and the parabolic antenna. Additionally, the external feedline between the feed and the antenna output port affects the gain and radiation pattern of the parabolic antenna, increasing the difficulty of designing and developing the parabolic antenna.

In related technology, a parabolic antenna is provided, where the parabolic antenna has multiple feeds and the multiple feeds are combined through a combiner, resulting in a complex structure for the feeds and their mounting structure on the reflector of the parabolic antenna.

In view of this, the embodiments of the present application provide a communication device capable of addressing the technical problems associated with conventional parabolic antennas mentioned above.

The structure of the communication device is further elaborated below in conjunction with the drawings and embodiments.

Referring to FIG. 3, the communication device includes an antenna. The antenna includes a feed 100 and a wiring board 200. The feed 100 includes a dipole unit, the dipole unit including a first dipole 110 and a second dipole 120. The second dipole 120 is formed on one side of the wiring board 200, that is, the second dipole 120 is integrated on a surface of the wiring board 200. For example, the second dipole 120 may be formed on the surface of the wiring board 200 by printing or other means.

The communication device further includes a communication apparatus. The communication apparatus may be a bridge device. The types of bridge devices may be referred to in the related description above and are not repeated here. The communication apparatus may include a circuit board 300. The circuit board 300 is a printed circuit board in the communication apparatus that carries a large number of electronic components. The circuit board 300 may not only be used to control the transmission of signals such as current and voltage in the communication apparatus to ensure stable operation of the communication apparatus but also provide protection and detection functions to prevent the communication apparatus from being interfered with by electricity or electromagnetic interference. For example, the protection and detection functions provided by the circuit board 300 may include overcurrent, overvoltage, and short-circuit protection. The circuit board 300 is a conventional structure in the communication apparatus, and its structure is not further described here. The first dipole 110 is formed on a surface of the circuit board 300. That is, the first dipole 110 is integrated on one side of the circuit board 300. For example, the first dipole 110 may be formed on one side of the circuit board 300 by printing or other means.

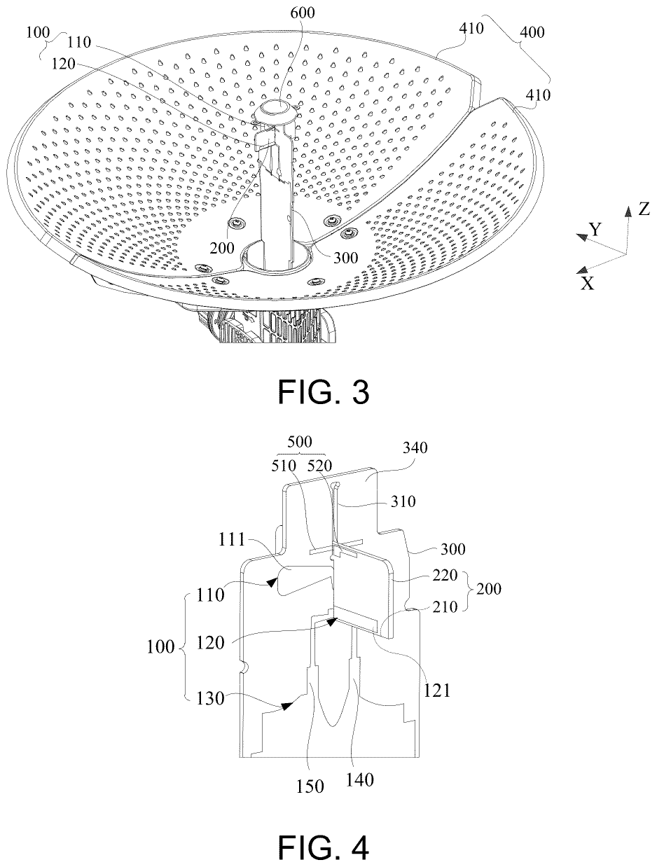

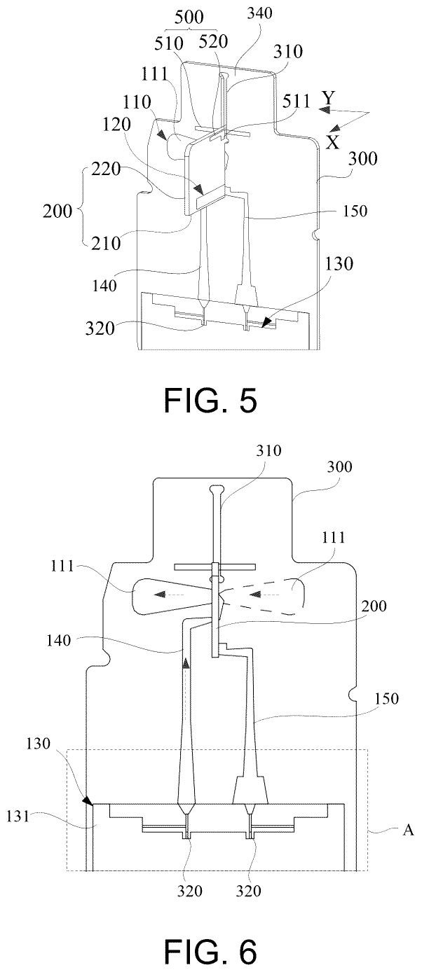

The first dipole 110 may be directly integrated on the surface of the circuit board 300. Alternatively, when the available space on the circuit board 300 is limited, the surface dimensions of the circuit board may be extended to provide sufficient space for integrating the first dipole 110. FIG. 4 and FIG. 5 respectively show schematic diagrams of the assembly of the wiring board 200 on the circuit board 300 from different perspectives. Referring to FIG. 4 and FIG. 5, the circuit board 300 is provided with a first slot 310. At least a portion of the wiring board 200 is inserted into the first slot 310 and connected to the circuit board 300 to achieve assembly and fixation of the wiring board 200 on the circuit board 300. For example, the wiring board 200 may be connected to the circuit board 300 by soldering or other means. The first dipole 110 and the second dipole 120 are both electrically connected to the circuit board 300 to enable electrical connection between the antenna and the communication apparatus, achieving signal transmission and reception functions of the antenna at the first dipole 110 and the second dipole 120. The first dipole 110 and the second dipole 120 may form dual-channel signal ports of the antenna. That is, the first dipole 110 forms one signal port of the dual-channel signal ports, and the second dipole 120 forms the other signal port of the dual-channel signal ports.

The circuit board 300 is provided with an extension portion 340, and the first slot 310 may be provided in the extension portion 340 to enable assembly and fixation of the wiring board 200 on the circuit board 300 while preventing the provision of the first slot 310 from affecting the area for arranging electronic components on the circuit board 300.

Taking the first dipole 110 as an example, the process of the signal transmission and reception functions of the antenna at one of the signal ports is further elaborated below.

The communication apparatus may provide a signal (for example, a current signal) to the first dipole 110, so that when the signal is transmitted within the first dipole 110, electromagnetic waves may be formed and radiated outward along the antenna, achieving the signal transmission function of the antenna at the first dipole 110. Alternatively, the first dipole 110 may also receive a signal (for example, an electromagnetic wave signal) and transmit the received signal to the communication apparatus, thereby achieving the signal reception function of the antenna at the first dipole 110.

The process of the signal transmission and reception functions of the antenna at the signal port of the second dipole 120 may be referred to in the related description of the first dipole 110 and is not repeated here.

In the communication device, the first dipole 110 of the feed 100 of the antenna is integrated on the circuit board 300, and the second dipole 120 of the feed 100 is integrated on the wiring board 200. In this way, after the wiring board 200 is assembled to the circuit board 300 and connected thereto, both the first dipole 110 and the second dipole 120 may be electrically connected to the circuit board 300, achieving electrical connection between the antenna and the communication apparatus while providing the communication device with a high degree of integration.

The connection between the wiring board 200 and the circuit board 300 may be completed during the production process of the communication device, achieving electrical connection between the antenna and the communication apparatus. When the communication device of the present application is installed at a construction site, there is no need for the communication apparatus to be connected to the antenna output port of the antenna via an external feedline, nor is there a need to connect the feed 100 to the antenna output port of the antenna. Therefore, when the communication device of the present application is fixed at a construction site, the internal antenna may be fixed at the construction site. Compared to conventional parabolic antennas, the communication device of the present application may simplify the assembly process of the antenna and the communication apparatus, reducing the construction cost during installation. The antenna of the present application also does not need to have an antenna output port, simplifying the structure of the antenna.

Moreover, since no external feedline is required, signal attenuation during transmission between the communication apparatus and the first dipole 110, as well as between the communication apparatus and the second dipole 120, may be avoided, improving the gain of the antenna, enhancing the signal quality of the communication apparatus, and thereby improving the coverage performance and coverage distance of the communication apparatus, facilitating long-range wireless communication.

The feed 100 may be fixed to the antenna through the circuit board 300 and the wiring board 200, while eliminating the need for a combiner or other fixing structures in the feed 100, simplifying the structure of the feed 100 and its fixation on the antenna.

Referring to FIG. 5, the wiring board 200 has a long side 210 and a short side 220. When the wiring board 200 is inserted into the first slot 310, the long side 210 intersects with the surface of the circuit board 300 and is connected to the circuit board 300 and the short side 220 is located at a side of the circuit board 300. The second dipole 120 is disposed on a side of the wiring board 200 adjacent to the long side 210, so that the second dipole 120 may be electrically connected to the circuit board 300, enabling signal transmission and reception functions of the antenna at the second dipole 120.

In some embodiments, the dipole unit may comprise orthogonal dual-polarized dipoles. The first dipole 110 is a vertically polarized dipole of the orthogonal dual-polarized dipoles. The second dipole 120 is a horizontally polarized dipole of the orthogonal dual-polarized dipoles. In this way, the antenna may transmit and receive signals along the electric field direction of the first dipole 110 at the first dipole 110. The antenna may also transmit and receive signals along the electric field direction of the second dipole 120 at the second dipole 120. This enables the antenna to receive and transmit signals in multiple directions.

The electric field direction of the vertically polarized dipole is perpendicular to the electric field direction of the horizontally polarized dipole. For a communication device, the vertically polarized dipole may be understood as a dipole whose electric field direction is perpendicular to the ground when the communication device is installed at an installation site, and the horizontally polarized dipole may be understood as a dipole whose electric field direction is parallel to the ground when the communication device is installed at an installation site.

In the present application, the first dipole 110 is a vertically polarized dipole, and its electric field direction may correspond to the Y direction in FIG. 5. The second dipole 120 is a horizontally polarized dipole, and its electric field direction may correspond to the X direction in FIG. 5. It should be noted that when the communication device is installed at an installation site and its pitch angle is adjusted, the electric field directions of the first dipole 110 and the second dipole 120 may change relative to the ground.

Referring to FIG. 5, a length of the first slot 310 is greater than a length of the short side 220, and a slot width of the first slot 310 is greater than a thickness of the wiring board 200, so that the wiring board 200 may be inserted into the first slot 310, enabling assembly of the wiring board 200 on the circuit board 300.

The long side 210 may be disposed perpendicular to the surface of the circuit board 300, and the short side 220 may be disposed parallel to the surface of the circuit board 300. In this case, the wiring board 200 is disposed perpendicular to the circuit board 300, so that the second dipole 120 may form orthogonal dual-polarized dipoles with the first dipole 110.

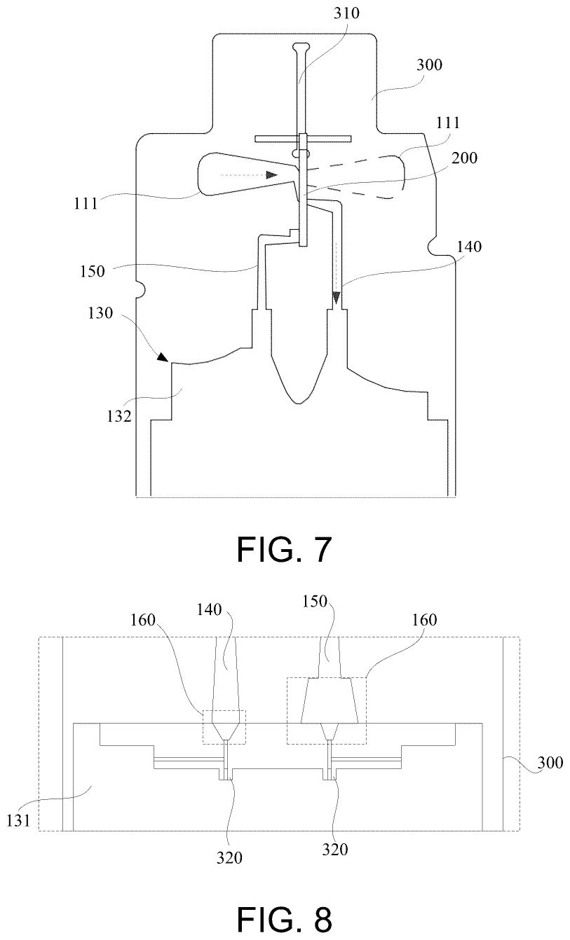

FIG. 6 and FIG. 7 respectively show schematic diagrams of assembly of a wiring board 200 on a circuit board 300 from different perspectives. FIG. 6 and FIG. 7 respectively show two surfaces of the circuit board 300 in the thickness direction. FIG. 6 shows a front side of a balun structure 130 on the circuit board 300. FIG. 7 shows a back side of the balun structure 130 on the circuit board 300. That is, the balun structure 130 is formed on two surfaces of the circuit board 300 in the thickness direction.

Referring to FIG. 6 and FIG. 7, the first dipole 110 includes two first radiating arms 111. The two first radiating arms 111 may be formed on two surfaces of the circuit board 300 in a thickness direction, so that one of the two first radiating arms 111 is electrically connected to a radio frequency port 320 of the circuit board 300, and the other of the two first radiating arms 111 may be grounded on the circuit board 300.

Referring to FIG. 4 and FIG. 5, the second dipole 120 includes two second radiating arms 121, the two second radiating arms 121 may be formed on a same surface of the wiring board 200. In this way, one of the two second radiating arms 121 may be electrically connected to the radio frequency port 320 of the circuit board 300, and the other of the two second radiating arms 121 may be grounded on the circuit board 300.

In some embodiments, the two second radiating arms 121 may also be formed on two surfaces of the wiring board 200 in a thickness direction. Similarly, one of the two second radiating arms 121 may be electrically connected to the radio frequency port 320 of the circuit board 300, and the other of the two second radiating arms 121 may be grounded on the circuit board 300.

Taking the example where the two second radiating arms 121 may be formed on a same surface of the wiring board 200, the structure of the communication device is further elaborated below.

Referring to FIG. 6 and FIG. 7, the two first radiating arms 111 are centrally symmetric to each other. Moreover, the two first radiating arms 111 are distributed on two sides of the first slot 310, so that the two first radiating arms 111 may form the first dipole 110. Referring to FIG. 4 and FIG. 5, the two second radiating arms 121 are centrally symmetric to each other, the two second radiating arms being disposed on two sides of the wiring board 200, so that the two second radiating arms 121 may form the second dipole 120. In this way, the first dipole 110 may be a centrally symmetric structure. The second dipole 120 may also be a centrally symmetric structure. The antenna may include a parabolic antenna. When the antenna is a parabolic antenna, a phase center of the feed 100 (for example, the first dipole or the second dipole) may be located at the focus of the parabolic surface of the parabolic antenna to increase the gain of the antenna and the transmission distance of the communication device. The phase center of the first dipole may be regarded as a symmetry center of the first dipole. The phase center of the second dipole may be regarded as a symmetry center of the second dipole.

Moreover, since the two first radiating arms 111 are distributed symmetrically about a center on two sides of the first slot 310, when the wiring board 200 is inserted into the first slot 310, the two second radiating arms 121 may be distributed on two sides of the first dipole 110, so that the dipole unit may form orthogonal dual-polarized dipoles.

Referring to FIG. 4, the first radiating arm 111 may include, but is not limited to, a fan-shaped microstrip. For example, the first radiating arm 111 may also include a rectangular microstrip or the like. When the first radiating arm 111 is a fan-shaped microstrip, in a direction in which the two first radiating arms 111 extend away from each other, a width of the fan-shaped microstrip may gradually increase, thereby increasing a bandwidth of the antenna at the first dipole 110. A direction of the width of the fan-shaped microstrip is parallel to the short side 220.

Correspondingly, the second radiating arm 121 may include a rectangular or other shaped microstrip 530. In the present application, the shapes of the first radiating arm 111 and the second radiating arm 121 are not particularly limited.

A length of the first radiating arm 111 and the second radiating arm 121 may be greater than or equal to one-fifth of a wavelength of a center frequency of the parabolic antenna and less than or equal to one-third of the wavelength of the center frequency of the parabolic antenna. The lengths of the first radiating arm 111 and the second radiating arm 121 may be the same or different. When the lengths of the first radiating arm 111 and the second radiating arm 121 are the same, for example, the lengths of the first radiating arm 111 and the second radiating arm 121 may both be one-quarter of the wavelength of the center frequency of the parabolic antenna.

FIG. 6 and FIG. 7 respectively show schematic diagrams of assembly of a wiring board 200 on a circuit board 300 from different perspectives. FIG. 6 and FIG. 7 respectively show two surfaces of the circuit board 300 in the thickness direction. FIG. 6 shows a front side of the balun structure 130 on the circuit board 300. FIG. 7 shows a back side of the balun structure 130 on the circuit board 300. That is, the balun structure 130 is formed on two surfaces of the circuit board 300 in the thickness direction.

Referring to FIG. 6 in conjunction with FIG. 7, in some embodiments, the feed 100 further includes first transmission lines 140 and second transmission lines 150. Each of the two first radiating arms 111 corresponds to one first transmission line 140; and one of the two first radiating arms 111 is electrically connected to the radio frequency port 320 on the circuit board 300 through the corresponding first transmission line 140, and the other is grounded through the corresponding first transmission line 140, so that the two first radiating arms 111 form radiation.

Each of the two second radiating arms 121 corresponds to one second transmission line 150. One of the two second radiating arms 121 is electrically connected to the radio frequency port 320 through the corresponding second transmission line 150, and the other is grounded through the corresponding second transmission line 150, so that the two second radiating arms 121 form radiation.

Both the first transmission line 140 and the second transmission line 150 are formed on the circuit board 300 to enable fixation of the first transmission line 140 and the second transmission line 150. In the embodiments of the present application, the number of first transmission lines 140 is two. The two first transmission lines 140 are formed on two surfaces of the circuit board 300 in the thickness direction, so that each of the two first radiating arms 111 corresponds to one first transmission line 140 and is electrically connected to the radio frequency port 320 or grounded through the corresponding first transmission line 140.

In the embodiments of the present application, the number of second transmission lines 150 is two. The two second transmission lines 150 are similarly formed on two surfaces of the circuit board 300 in the thickness direction, so that each of the two second radiating arms 121 corresponds to one second transmission line 150 and is electrically connected to the radio frequency port 320 or grounded through the corresponding second transmission line 150.

Referring to FIG. 6 in conjunction with FIG. 7, in some embodiments, the feed 100 further includes a balun structure 130. The balun structure 130 is located on the circuit board 300 and electrically connected to the radio frequency port 320 on the circuit board 300. Each of the two first radiating arms 111 is electrically connected to the balun structure 130 through one first transmission line 140 to form radiation while enabling electrical connection of one first radiating arm 111 to the radio frequency port 320 through the balun structure 130.

Each of the two second radiating arms 121 is electrically connected to the balun structure 130 through one second transmission line 150 to form radiation while enabling electrical connection of one second radiating arm 121 to the radio frequency port 320 through the balun structure 130.

Referring to FIG. 6 in conjunction with FIG. 7, the balun structure 130 (not labeled) is configured to achieve a 180° phase shift, so that currents in the two first radiating arms 111 flow in the same direction, and currents in the two second radiating arms 121 flow in the same direction. The current direction of the first radiating arms 111 is indicated by dashed arrows in FIG. 6 for better understanding.

The radio frequency port 320 may be understood as a radio frequency output port that provides a signal source for the first dipole 110 and the second dipole 120 through the balun structure 130. Correspondingly, when the first dipole 110 and the second dipole 120 receive signals, the radio frequency port 320 may also be used for receiving signals from the first dipole 110 and the second dipole 120.

Since the balun structure 130 is configured to achieve a 180°phase shift, when the radio frequency port 320 on the circuit board 300 transmits signals to the two first transmission lines 140 through the balun structure 130, the currents in the two first transmission lines 140 flow in opposite directions, producing no radiation, while the currents in the two first radiating arms 111 flow in the same direction. The current direction of the first transmission lines 140 is also indicated by dashed arrows in FIG. 6 for better understanding. In this way, while one of the two first radiating arms 111 radiates externally, the other of the two first radiating arms 111 may be grounded, thereby achieving radiation and grounding of the first dipole 110.

The two first transmission lines 140 corresponding to the two first radiating arms 111 overlap in the thickness direction of the circuit board 300. In this way, when the currents in the two first transmission lines 140 flow in opposite directions, the electric fields formed by the two first transmission lines 140 may cancel each other out, producing no radiation.

When ensuring that the electric fields formed by the two first transmission lines 140 may cancel each other out and produce no radiation, the two first transmission lines 140 may also be positioned close to each other.

The two second transmission lines 150 corresponding to the two second radiating arms 121 overlap in the thickness direction of the circuit board 300. In this way, when the currents in the two second transmission lines 150 flow in opposite directions, the electric fields formed by the two second transmission lines 150 may cancel each other out, producing no radiation.

Similarly, when it is ensured that the electric fields formed by the two second transmission lines 150 may cancel each other out and produce no radiation, the two second transmission lines 150 may also be positioned close to each other.

Since the two first radiating arms 111 are formed on two surfaces of the circuit board 300, it is possible to prevent one of the two first transmission lines 140 from being covered by the other on the same side of the circuit board 300, ensuring normal radiation and grounding of the two first radiating arms 111.

Referring to FIG. 7 in conjunction with FIG. 5, correspondingly, when the radio frequency port 320 on the circuit board 300 transmits signals to the two second transmission lines 150 through the balun structure 130, the currents in the two second transmission lines 150 flow in opposite directions, producing no radiation, and the currents in the two second radiating arms 121 flow in the same direction. In this way, while one of the two second radiating arms 121 radiates externally, the other of the two second radiating arms 121 may be grounded, thereby achieving radiation and grounding of the second dipole 120.

It should be noted that the balun structure 130 may be an existing structure on the circuit board 300 of a communication apparatus such as a bridge device. Alternatively, the balun structure 130 may also be an additional structure added to the circuit board 300 of the communication apparatus. The principle by which the balun structure 130 achieves a 180° phase shift may be determined through existing technology and is not repeated here.

Referring to FIG. 6 and FIG. 7, the balun structure 130 includes a microstrip balun. The microstrip balun includes a first microstrip balun 131 and a second microstrip balun 132. Referring to FIG. 6, the first microstrip balun 131 is located on a surface of the circuit board 300 provided with the radio frequency port 320. Referring to FIG. 7, the second microstrip balun 132 is located on a surface of the circuit board 300 opposite to the first microstrip balun 131 and is grounded.

One of the two first radiating arms 111 is electrically connected to the first microstrip balun 131 through the corresponding first transmission line 140, and the other is electrically connected to the second microstrip balun 132 through the corresponding first transmission line 140, thereby achieving radiation and grounding of the first dipole 110.

One of the two second radiating arms 121 is electrically connected to the first microstrip balun 131 through the corresponding second transmission line 150, and the other is electrically connected to the second microstrip balun 132 through the corresponding second transmission line 150, thereby achieving radiation and grounding of the second dipole 120.

Both the first transmission line 140 and the second transmission line 150 may be microstrip 530 transmission lines or other linear structures capable of transmitting signals. The first transmission line 140 and the second transmission line 150 may also be integrated on the circuit board 300 by printing or other means.

Referring to FIG. 8, at least one of the first transmission line 140 and the second transmission line 150 electrically connected to the first microstrip balun 131 may further be provided with a tapered transmission line 160. The tapered transmission line 160 is a transmission line whose line width gradually changes in the length direction. That is, the tapered transmission line 160 is a part of the first transmission line 140 or the second transmission line 150. During signal transmission, the provision of the tapered transmission line 160 enables better impedance matching.

The tapered transmission line 160 has a first section and a second section. Compared to the first section, the second section is closer to the first microstrip balun 131. The second section is electrically connected to the first microstrip balun 131. In a direction toward the first microstrip balun 131, the line width of the tapered transmission line 160 in the second section may gradually decrease. For example, the second section of the tapered transmission line 160 may be formed as an inverted triangle or an inverted trapezoid. In a direction toward the first microstrip balun 131, the line width of the tapered transmission line 160 in the first section may gradually increase. For example, the first section of the tapered transmission line 160 may be formed as a triangle or a trapezoid. In the present application, the shape of the tapered transmission line 160 is not particularly limited.

In FIG. 8, both the first transmission line 140 and the second transmission line 150 are provided with a tapered transmission line 160. In some embodiments, the tapered transmission line 160 may also be provided solely on the first transmission line 140 or the second transmission line 150. In the present application, the position of the tapered transmission line 160 is not particularly limited.

After the feed 100 is integrated on the circuit board 300 and the wiring board 200, optimizing the assembly process and yield rate of the feed 100 and the circuit board 300 during production is also a technical issue that needs to be addressed.

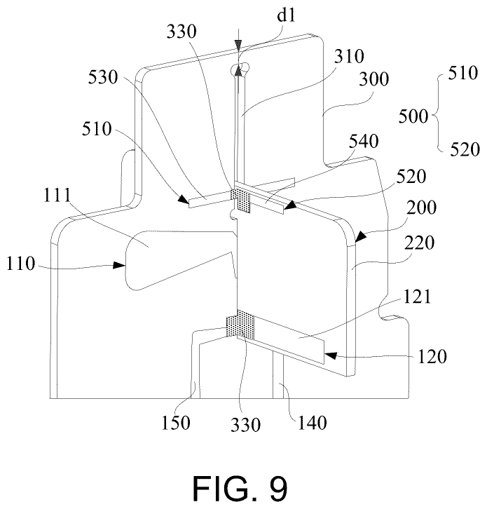

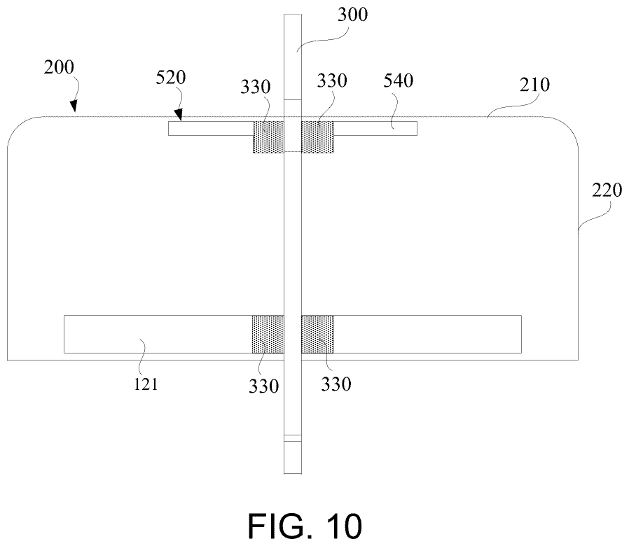

FIG. 9 and FIG. 10 respectively show partial schematic diagrams of the assembly of the wiring board 200 on the circuit board 300 from different perspectives.

Referring to FIG. 9, when at least a portion of the wiring board 200 is inserted into the first slot 310, the wiring board 200 intersects with the circuit board 300 and is connected to the circuit board through a plurality (for example, four) of connection portions 330 to enable fixation of the wiring board 200 on the circuit board 300 through the connection portions 330. Referring to FIG. 10, the connection portions 330 may be distributed on a same surface of the wiring board 200. The connection portions 330 may include, but are not limited to, solder joints to enable soldering of the wiring board 200 to the circuit board 300 through the connection portions 330. For example, the connection portions 330 may include conductive adhesive portions.

Compared to a situation where multiple connection portions 330 are disposed on different surfaces of the wiring board 200 (for example, distributed on two surfaces of the wiring board 200 in the thickness direction), the provision of the connection portions 330 on a same surface of the wiring board 200 allows the connection between the wiring board 200 and the circuit board 300 to be completed on the same surface of the wiring board 200 without the need to flip the wiring board 200. This not only simplifies the connection process between the wiring board 200 and the circuit board 300, facilitating the connection between the circuit board 300 and the wiring board 200, improving the installation efficiency of the wiring board 200 on the circuit board 300, and enhancing the production efficiency of the communication device, but also reduces the likelihood of damage due to collisions between the antenna and some equipment (for example, the communication apparatus) caused by flipping operations, improving the yield rate of the communication device.

Moreover, with the connection portions 330 disposed on the same surface of the wiring board 200, when the connection portions 330 are solder joints, the tooling required for soldering may also be simplified, helping to reduce the production cost of the communication device.

Referring to FIG. 9, when the connection portions 330 are distributed on the same surface of the wiring board 200, the connection portions 330 may also be located between the second radiating arms 121 and the second transmission lines 150, electrically connecting the second radiating arms 121 to the second transmission lines 150, thereby achieving electrical connection of the second radiating arms 121 to the first microstrip balun 131 and the second microstrip balun 132.

Since the wiring board 200 is inserted into the first slot 310 of the circuit board 300, if the first slot 310 is located at a top edge of the circuit board 300, when the circuit board 300 is subjected to external force compression and deformation on two sides in the length direction of the first slot 310, it may cause the connection portions 330 (for example, solder joints) between the wiring board 200 and the circuit board 300 to detach, affecting the assembly of the wiring board 200 on the circuit board 300 and even affecting the electrical connection between the second radiating arms 121 and the second transmission lines 150.

Referring to FIG. 9, the first slot 310 may be located in a middle region of the circuit board 300. The middle region of the circuit board 300 may be understood as a region including the center of the circuit board 300, rather than an edge region. This may prevent detachment of the connection portions 330 (for example, solder joints) when two sides of the circuit board 300 in the length direction of the first slot 310 are subjected to compression, enhancing the stability of the connection between the wiring board 200 and the circuit board 300. At the same time, the electrical connection effect between the second radiating arms 121 and the second transmission lines 150 will also be more stable.

A distance d1 between the first slot 310 and a top edge of the circuit board 300 may be greater than or equal to 3 mm and less than or equal to 10 mm to further enhance the stability of the connection portions 330, preventing detachment of the connection portions 330 (for example, solder joints) when two sides of the circuit board 300 in the length direction of the first slot 310 are subjected to compression. For example, the distance d1 may be 3 mm, 4 mm, 5 mm, 6 mm, or the like.

In some embodiments, the antenna may further include a first reflector 400 (referring to FIG. 3). The first reflector 400 has a reflective surface. The reflective surface of the first reflector 400 is a paraboloid. In this case, the first reflector 400 may be understood as a parabolic reflector in a parabolic antenna, and the antenna may be a parabolic antenna. The circuit board 300 may be located within a reflection region of the reflective surface, so that the communication apparatus is integrated within the antenna while enabling the antenna to have the high-gain characteristics of a parabolic antenna. Since the communication apparatus and the antenna do not need to be connected through an external feedline, the impact of an external feedline on the gain and radiation pattern of the parabolic antenna may be avoided, improving the gain of the antenna, enhancing the signal quality of the communication apparatus, and thereby improving the coverage performance and coverage distance of the communication apparatus, facilitating long-range wireless communication.

A parabolic antenna requires the dipole to be designed at the focus of the parabolic surface. In the present application, if the first dipole 110 and the second dipole 120 are arranged at a same height plane in a Z direction (as shown in FIG. 3) of the circuit board 300, the first dipole 110 and the second dipole 120 would overlap in the Z direction, and the first transmission line 140 and the second transmission line 150 would also overlap, leading to signal interference between the first dipole 110 and the second dipole 120, severely degrading the performance of the antenna and impairing the electrical performance of the communication device.

To address this, the first dipole 110 and the second dipole 120 of the present application are spaced apart along a line (not shown) connecting the focus of the parabolic surface and a center of the parabolic surface. Referring to FIG. 9, the second dipole 120 may be located below the first dipole 110.

If the second dipole 120 were located above the first dipole 110, the second transmission line 150 would be extended, causing the second transmission line 150 to overlap with the first dipole 110, leading to signal interference between the first dipole 110 and the second dipole 120.

Therefore, when the second dipole 120 may be located below the first dipole 110, signal interference due to overlapping of the first dipole 110 and the second dipole 120 may be avoided, ensuring the performance of the antenna and the electrical performance of the communication device.

It should be noted that the positions of the focus and the center of the parabolic surface may be referred to in the related description of existing parabolic reflectors and are not repeated here.

Referring to FIG. 9, in some embodiments, the first dipole 110 may be located at the focus of the parabolic surface to ensure that the position of the first dipole 110 meets the design requirements of the parabolic antenna for dipoles. In this case, the symmetry center of the two first radiating arms 111 of the first dipole 110 is also located at the focus of the parabolic surface. At this time, the second dipole 120 is adjacent to the center of the parabolic surface, and the symmetry center of the two second radiating arms 121 of the second dipole 120 is located below the focus of the parabolic surface along the line mentioned above.

Alternatively, in some embodiments, when the first dipole 110 and the second dipole 120 are spaced apart along the line (not shown) connecting the focus of the parabolic surface and the center of the parabolic surface, the second dipole 120 may be located at the focus of the parabolic surface, with the first dipole 110 still located above the second dipole 120 to ensure that the position of the second dipole 120 meets the design requirements of the parabolic antenna for dipoles. In this case, the symmetry center of the two second radiating arms 121 of the second dipole 120 is located at the focus of the parabolic surface. The symmetry center of the two first radiating arms 111 of the first dipole 110 is located along the aforementioned line and above the focus of the parabolic surface. In the embodiments of the present application, the positions of the first dipole 110 and the second dipole 120 are not particularly limited.

Taking the example where the first dipole 110 is located at the focus of the parabolic surface and the second dipole 120 is located below the first dipole 110, the structure of the communication device is further elaborated below.

The phase center of a dipole refers to the center position of the radiation pattern of the dipole. Changes in the phase center of a dipole directly affect the performance and communication quality of the antenna. The phase center of a dipole may also be understood as the symmetry center of the two radiating arms of the dipole.

The greater the spacing between the first dipole 110 and the second dipole 120 along the line mentioned above is, the greater the isolation between the first dipole 110 and the second dipole 120 becomes. However, if the spacing is too large, the second dipole 120 would be too close to the center of the parabolic surface. In this case, the phase center of the second dipole 120 deviates further from the focus of the parabolic surface. This causes the electromagnetic waves radiated by the second dipole 120 to reach the reflective surface of the parabolic surface with unequal phases. As a result, the reflected waves fail to form fully parallel plane waves, resulting in increased side lobes and reduced gain for the second dipole 120.

Therefore, the distance between the first dipole 110 and the second dipole 120 along the line mentioned above is greater than or equal to one-ninth of a wavelength of a center frequency of the parabolic antenna and less than or equal to one-sixth of the wavelength of the center frequency of the parabolic antenna. This effectively prevents signal interference between the first dipole 110 and the second dipole 120 while avoiding a reduction in the gain of the second dipole 120. For example, the distance between the first dipole 110 and the second dipole 120 along the line may be one-eighth of a wavelength, in which case the distance between the first dipole 110 and the second dipole 120 along the line mentioned above is approximately (rounded) 7 mm.

Referring to FIG. 9, a direction of the length of the first slot 310 is parallel to the line mentioned above and a short side 220 of the wiring board 200. The wiring board 200 is provided with a second slot on a side where the second dipole 120 is disposed, the second dipole 120 being disposed adjacent to a slot opening side of the second slot. When the wiring board 200 is inserted into the first slot 310, a portion of the wiring board 200 is inserted into the first slot 310 and rests on a slot wall of the first slot 310, with the second slot located below the first slot 310, so that the second dipole 120 is spaced apart below the first dipole 110 along the line mentioned above. Moreover, since the direction of the length of the first slot 310 is parallel to the line mentioned above and the short side 220 of the wiring board 200, when the wiring board 200 is inserted into the first slot 310, the wiring board 200 may be perpendicular to the circuit board 300, so that the second dipole 120 is perpendicular to the first dipole 110, forming a dipole unit of orthogonal dual-polarized dipoles.

Since the first dipole 110 and the second dipole 120 are spaced apart along the line mentioned above, the distance between the first dipole 110 and the center of the parabolic surface differs from the distance between the second dipole 120 and the center of the parabolic surface. This results in some differences in the gains of the first dipole 110 and the second dipole 120. For example, when the distance between the first dipole 110 and the second dipole 120 along the line is 7 mm, there is a 1 dBi difference in the gains of the first dipole 110 and the second dipole 120, with the gain of the second dipole 120 being less than the gain of the first dipole 110.

To address this, referring to FIG. 9, the communication device may further include a microstrip parasitic unit 500. The microstrip parasitic unit 500 is located on a side of the dipole unit away from the communication apparatus and is configured to at least enhance a gain of the second dipole 120 to reduce a gain difference between the first dipole 110 and the second dipole 120. After reducing the gain difference between the first dipole 110 and the second dipole 120, the time required for engineering alignment may be reduced, improving the installation efficiency of the communication device. The gain difference may also be referred to as gain fluctuation.

It should be noted that by at least enhancing the gain of the second dipole 120, the microstrip parasitic unit 500 may also reduce the angular fluctuation between the first dipole 110 and the second dipole 120, further reducing the time required for engineering alignment and improving the installation efficiency of the communication device.

The microstrip parasitic unit 500 includes a first microstrip unit 510 and a second microstrip unit 520. Each of the first microstrip unit 510 and the second microstrip unit 520 includes two microstrips. For ease of description, the microstrips of the first microstrip unit 510 are referred to as first microstrips 530, and the microstrips of the second microstrip unit 520 are referred to as second microstrips 540. The two first microstrips 530 of the first microstrip unit 510 are symmetrically disposed on the circuit board 300. For example, the two first microstrips 530 of the first microstrip unit 510 are disposed on the circuit board 300 in an axisymmetric manner.

The two second microstrips 540 of the second microstrip unit 520 are symmetrically disposed on the wiring board 200. For example, the two second microstrips 540 of the second microstrip unit 520 are disposed on the wiring board 200 in an axisymmetric manner.

Referring to FIG. 9, when at least a portion of the wiring board 200 is inserted into the first slot 310, the two first microstrips 530 of the first microstrip unit 510 are connected to the two second microstrips 540 of the second microstrip unit 520 to form the microstrip parasitic unit 500, so as to control the degree of gain enhancement of the microstrip parasitic unit 500 for the first dipole 110 and the second dipole 120, reducing the gain difference between the first dipole 110 and the second dipole 120 through the microstrip parasitic unit 500. For example, when the gain enhancement effect of the microstrip parasitic unit 500 on the second dipole 120 is greater than the gain enhancement effect on the first dipole 110, the gain difference and angular fluctuation between the first dipole 110 and the second dipole 120 may be reduced.

Referring to FIG. 9, some connection portions 330 may be located at a connection between the first microstrip 530 and the second microstrip 540. Other connection portions 330 may be located at an intersection between the second radiating arm 121 and the second transmission line 150. When the connection portion 330 is located at the connection between the first microstrip 530 and the second microstrip 540, the first microstrip 530 may further have a solder pad 511 (referring to FIG. 5). The solder pad 511 is located on a side of the first microstrip 530 facing the second radiating arm 121 and connected to the first microstrip 530 to increase a connection area of the connection portion 330 to the wiring board 200 and the circuit board 300, enhancing the connection effect between the wiring board 200 and the circuit board 300. The solder pad 511 may include, but is not limited to, a solder pad with dimensions of 1.8×1.8 mm.

A length of the first microstrip 530 is greater than or equal to one-ninth of a wavelength of a center frequency of the parabolic antenna and less than or equal to one-seventh of the wavelength of the center frequency of the parabolic antenna. For example, the length of the first microstrip 530 may be one-eighth of the wavelength of the center frequency of the parabolic antenna. When the length of the first microstrip 530 is one-eighth of the wavelength of the center frequency of the parabolic antenna, the length of the first microstrip 530 may be 6.7 mm.

A length of the second microstrip 540 may be one-tenth of the wavelength of the center frequency of the parabolic antenna.

By limiting the length of the first microstrip 530, it is possible to prevent the length of the first microstrip 530 from being too long and affecting the radiation performance of the first dipole 110.

If the distance between the first microstrip 530 of the microstrip parasitic unit 500 and the second radiating arm 121 is one-quarter of a wavelength of the center frequency of the parabolic antenna, the second radiating arm 121 and the microstrip parasitic unit 500 generate an in-phase induced electromotive force, maximizing the gain enhancement value of the second dipole 120. At this time, the distance between the first microstrip 530 of the microstrip parasitic unit 500 and the first radiating arm 111 is less than one-quarter of the wavelength of the center frequency of the parabolic antenna, resulting in a smaller induced electromotive force generated by the microstrip parasitic unit 500 and a lower gain enhancement value for the first dipole 110.

If the distance between the first microstrip 530 and the second radiating arm 121 is less than one-quarter of a wavelength of the center frequency of the parabolic antenna, the induced electromotive force generated by the microstrip parasitic unit 500 is smaller, resulting in a lower gain enhancement value for the second dipole 120. At this time, the distance between the first microstrip 530 of the microstrip parasitic unit 500 and the first radiating arm 111 is greater than one-quarter of the wavelength of the center frequency of the parabolic antenna, and the first radiating arm 111 and the microstrip parasitic unit 500 generate an in-phase induced electromotive force, resulting in a maximum gain enhancement value for the first dipole 110.

Therefore, the distance between the first microstrip 530 of the microstrip parasitic unit 500 and the second radiating arm 121 in the present application is one-quarter of a wavelength of the center frequency of the parabolic antenna, and the distance between the first microstrip 530 of the microstrip parasitic unit 500 and the first radiating arm 111 is less than one-quarter of the wavelength of the center frequency of the parabolic antenna, to ensure that the gain enhancement effect of the microstrip parasitic unit 500 on the second dipole 120 is greater than the gain enhancement effect on the first dipole 110, reducing the gain difference between the first dipole 110 and the second dipole 120.

Referring to FIG. 9, compared to the second microstrip 540, the first microstrip 530 is closer to the first radiating arm 111. If the width of the first microstrip 530 is too large, it would similarly affect the radiation performance of the first dipole 110. If the width of the first microstrip 530 is too small, it would affect the gain enhancement effect on the first dipole 110 and the second dipole 120.

Therefore, the first microstrip 530 of the present application may use a microstrip line with an impedance of 50 Ω to 77 Ω. For example, when the length of the first microstrip 530 is one-eighth of a wavelength of the center frequency of the parabolic antenna, the width of the first microstrip 530 may be 0.8 mm. This ensures the gain enhancement effect of the microstrip parasitic unit 500 on the first dipole 110 and the second dipole 120 while avoiding an impact on the radiation performance of the first dipole 110.

To verify the effect of the microstrip parasitic unit 500 in reducing the gain difference between the first dipole 110 and the second dipole 120, the present application provides a comparative example and simulates the gain of the communication device of the present application and the comparative example at the first dipole 110 and the second dipole 120. The difference between the communication device of the comparative example and the communication device of the embodiments of the present application lies in the absence of the microstrip parasitic unit 500.

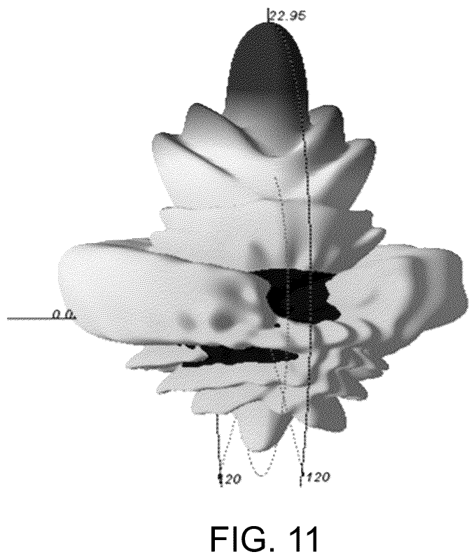

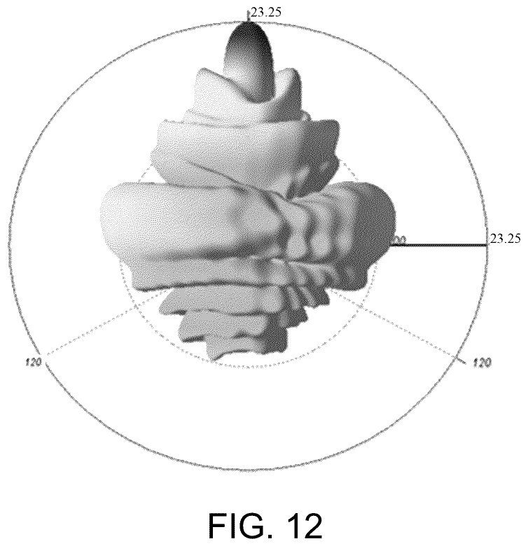

Referring to FIG. 11, the gain of the communication device in the comparative example at the first dipole 110 is 22.95 dBi. Referring to FIG. 12, the gain of the communication device in the embodiments of the present application at the first dipole 110 is 23.25 dBi. It may be seen that after adding the microstrip parasitic unit 500, the gain at the first dipole 110 increases from 22.95 dBi to 23.25 dBi.

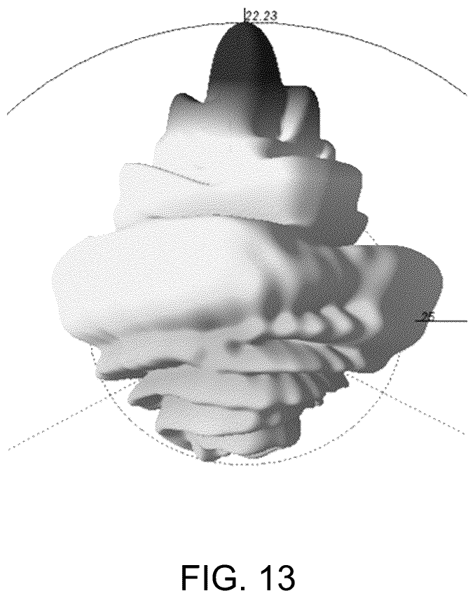

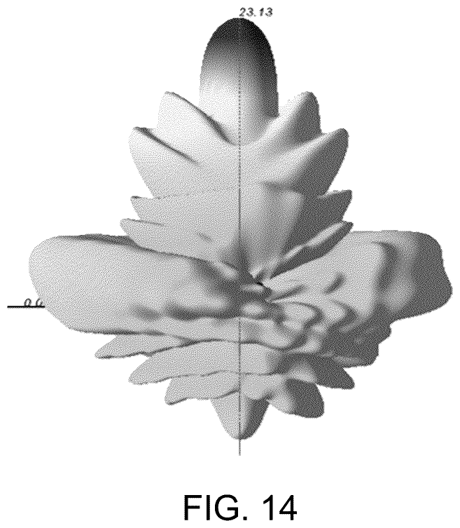

Referring to FIG. 13, the gain of the communication device in the comparative example at the second dipole 120 is 22.23 dBi. Referring to FIG. 14, the gain of the communication device in the embodiments of the present application at the second dipole 120 is 23.13 dBi.

It may be seen that after adding the microstrip parasitic unit 500, the gain at the second dipole 120 increases from 22.23 dBi to 23.13 dBi. Compared to the first dipole 110, the gain of the second dipole 120 has a larger increase, and after adding the microstrip parasitic unit 500, the gain difference between the second dipole 120 and the first dipole 110 is smaller.

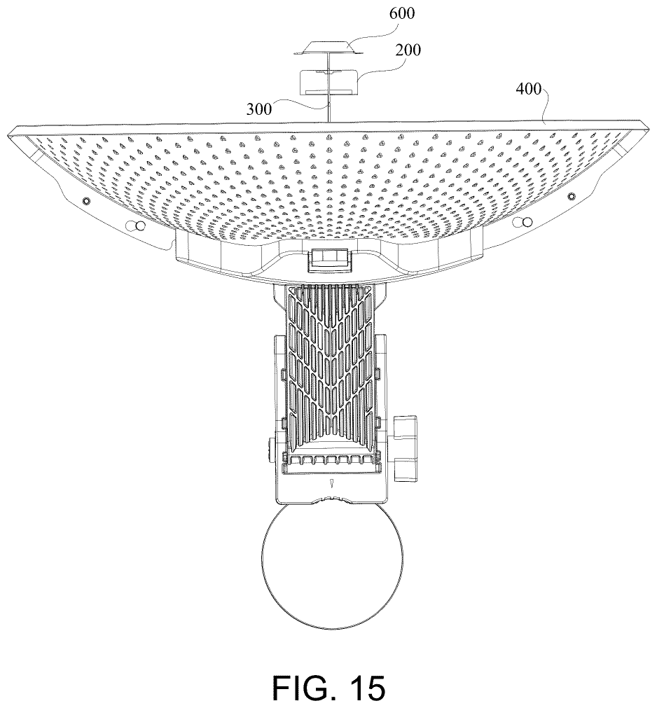

Referring to FIG. 15, in some embodiments, the antenna may further include a second reflector 600. The second reflector 600 is mounted on an end of the circuit board 300 away from the first reflector 400. The second reflector 600 covers the dipole unit. In this way, the second reflector 600 may reflect signals that have been reflected by the first reflector 400 again (secondary reflection), further increasing the gain of the dipole unit at the first dipole 110 and the second dipole 120.

When the second reflector 600 is mounted on the circuit board 300, it achieves fixation of the second reflector 600 on the circuit board 300. A reflective surface of the second reflector 600 is smaller than a reflective surface of the first reflector 400.

Specifically, the second reflector 600 is mounted on the extension portion 340 of the circuit board 300. The extension portion 340 may be installed within the second reflector 600, and the second reflector 600 may be fixed to the circuit board 300 by clamping or other means. Compared to the first reflector 400, the second reflector 600 is smaller in size; therefore, the extension portion 340 may be a partial protruding structure on an edge of the circuit board 300, so that the extension portion 340 may be installed within the second reflector 600. It should be noted that as the size of the second reflector 600 increases, the size of the extension portion 340 may also increase accordingly. Therefore, in the present application, the size of the extension portion 340 is not further limited.

Both the first reflector 400 and the second reflector 600 are reflectors of the antenna. In some embodiments, the reflector of the antenna may include only the first reflector 400, in which case the antenna has the characteristics of high gain and long-distance transmission of a parabolic antenna. In other embodiments, the reflector of the antenna may include only the second reflector 600, so that the antenna may be used as a directional antenna (for example, a 5 dBi directional antenna) in connection with the communication apparatus. In other embodiments, the reflector of the antenna may include both the first reflector 400 and the second reflector 600 to further increase the gain of the antenna.

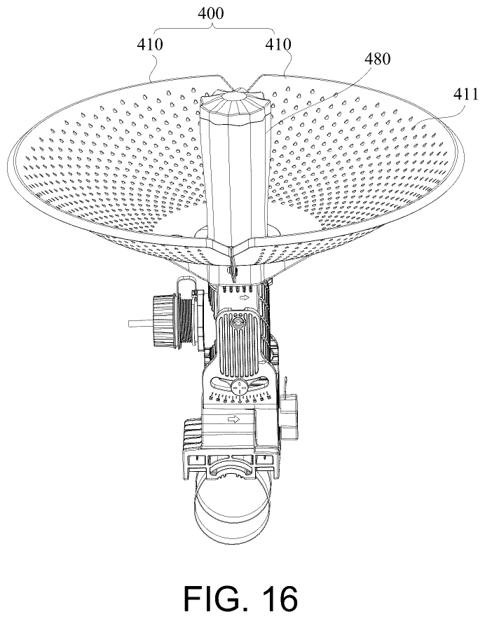

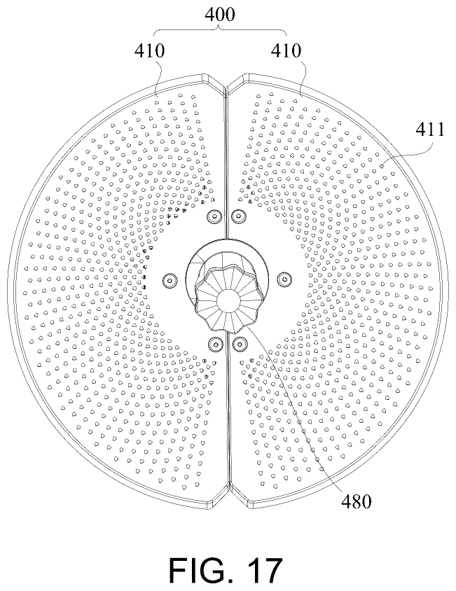

FIG. 16 and FIG. 17 respectively provide schematic structural diagrams of another communication device from different perspectives. Referring to FIG. 16 and FIG. 17, the communication device may further include a housing 480. The circuit board 300 is located within the housing 480 to prevent components of the communication device from being exposed on the surface of the communication device. The circuit board 300, the wiring board 200, and the second reflector 600 may all be located within the housing 480 to prevent the circuit board 300, the wiring board 200, and the second reflector 600 from being exposed on the surface of the communication device, enhancing the safety and aesthetics of the communication device.

The housing 480 may be a plastic housing 480. The housing 480 may be located at the central portion of the reflective surface of the first reflector 400 and connected to the reflective surface of the first reflector 400.

Referring to FIG. 17, the first reflector 400 may include two arc-shaped structures 410, the arc-shaped structures 410 being interconnected to form the first reflector 400, while reducing the size of the packaging structure of the first reflector 400 to facilitate transportation of the first reflector 400.

The two arc-shaped structures 410 are equal-arc structures. The first reflector 400 may have a circular reflective surface with a diameter of 360 mm at the aperture. The two arc-shaped structures 410 may be connected by fasteners, which may include, but are not limited to, screws, bolts, or the like.

The antenna with the first reflector 400 has a focal length to aperture ratio of 0.4, an antenna gain of 23 dBi, a horizontal angle of 10°, and a vertical angle of 9°. The horizontal angle of the antenna may be understood as the beamwidth of the main lobe of the antenna in a plane parallel to the ground. The vertical angle of the antenna may be understood as the beamwidth of the main lobe of the antenna in a plane perpendicular to the ground.

Referring to FIG. 17, the first reflector 400 may have a plurality of through holes 411, the through holes 411 being distributed on the reflective surface of the first reflector 400 to improve the wind resistance rating and aesthetics of the antenna. The through holes 411 may be located on the arc-shaped structures 410.

In addition, a conventional parabolic antenna has an antenna fixing structure connected to the back of the parabolic reflector. For example, the antenna fixing structure may be a fixing seat on the back of the parabolic reflector. The back of the parabolic reflector may be understood as the side of the parabolic reflector away from the parabolic surface. The antenna fixing structure is provided with only one clamp, which supports only the installation of the parabolic antenna on a vertical rod (perpendicular to the ground) at the installation site, making it difficult to meet the installation requirements in scenarios with complex site resources and high installation environment demands. For example, some communication devices on building rooftops require direct installation and fixation on horizontal rods (parallel to the ground) of rooftop walls. Therefore, the parabolic antenna needs to support installation modes for both horizontal and vertical rods to meet the needs of more equipment installation scenarios.

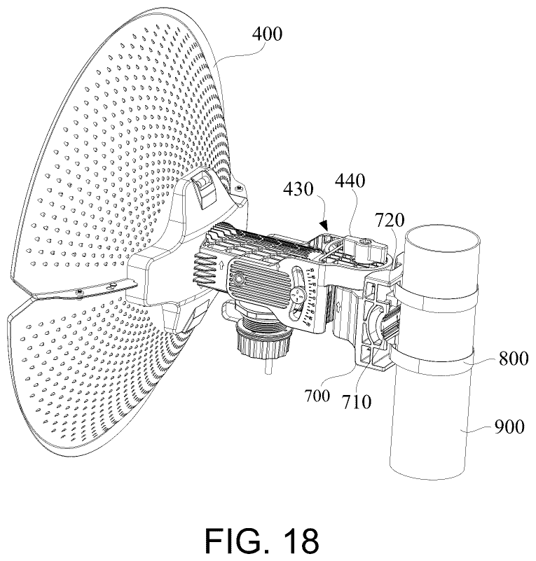

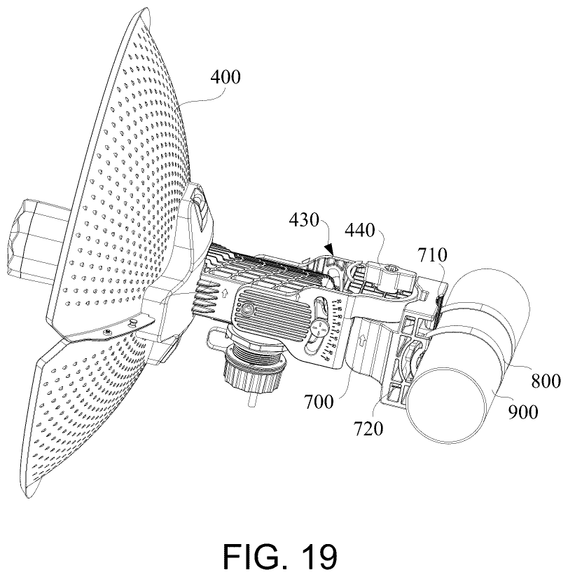

Referring to FIG. 18 and FIG. 19, the parabolic antenna further includes a mounting base 700 and a clamp 800, the mounting base 700 being mounted on a side of the first reflector 400 away from the feed 100. The mounting base 700 has a first recess and a second recess that intersect. The number of first recesses and the number of second recesses may each be one, so that the first recess and the second recess may each correspond to one fixing rod 900.

Alternatively, when the parabolic antenna needs to be fixed to two or more fixing rods 900, the number of first recesses and the number of second recesses may each be two or more; therefore, the number of first recesses and the number of second recesses are not particularly limited.

For ease of description, the first recess and the second recess are collectively referred to as recesses 710 below. That is, the mounting base 700 has two intersecting recesses 710. The shapes of the two recesses 710 are each adapted to the shape of a circumferential outer wall of the fixing rod 900. That is, the shapes of the two recesses 710 are each the same or similar to the shape of the circumferential outer wall of the fixing rod 900. For example, the recess 710 may be an arc-shaped concave surface that matches the shape of the circumferential outer wall of the fixing rod 900. Additionally, an end of the recess 710 in a length direction extends to a side wall of the mounting base 700 and forms a notch (not labeled) on the side wall of the mounting base 700. The length direction of the recess 710 is the same as the length direction of the fixed fixing rod 900, so that the recess 710 of the mounting base 700 may be exposed on the side wall of the mounting base 700, allowing the mounting base 700 of the parabolic antenna to be fixed on the fixing rod 900 while the fixing rod 900 may be fixed at the recess 710 and extend from the side wall of the mounting base 700, with the recess 710 limiting the assembly of the mounting base 700 on the fixing rod 900. The length direction of the recess 710 is the same as the length direction of the fixed fixing rod 900.

The clamp 800 is detachably mounted on the mounting base 700, and the clamp 800 may be selectively positioned at either of the two recesses 710 to fix the mounting base 700 on the fixing rod 900. In this way, through the provision of the clamp 800 and the mounting base 700, the parabolic antenna may be fixed on the fixing rod 900. Moreover, since the clamp 800 may be selectively positioned at either of the two recesses 710, by changing the position of the clamp 800 on the two recesses 710, the parabolic antenna may be fixed on a horizontal rod or a vertical rod of the fixing rod 900, enabling the communication device to adapt to different installation sites, allowing installation on horizontal or vertical rods at different installation sites.

The two recesses 710 are perpendicularly disposed on the mounting base 700. The number of clamps 800 may be two, and the two clamps 800 may be spaced apart along the extension direction of the recess 710 in which they are located, so that both clamps 800 encircle the horizontal rod or the vertical rod, enabling the horizontal rod or the vertical rod to be fixed within one of the two recesses 710, enhancing the stability of the installation of the communication device on the fixing rod 900.

Referring to FIG. 18, when the parabolic antenna is fixed on a vertical rod of the fixing rod 900, the two clamps 800 may be spaced apart at the recess 710 parallel to the axial direction of the vertical rod, so that the two clamps 800 may encircle the circumferential outer wall of the vertical rod.

Referring to FIG. 19, when the parabolic antenna is fixed on a horizontal rod of the fixing rod 900, the two clamps 800 may be spaced apart at the recess 710 parallel to the axial direction of the horizontal rod, so that the two clamps 800 may encircle the circumferential outer wall of the horizontal rod.

If the fixing rod 900 at the installation site includes, in addition to the vertical rod and the horizontal rod, a fixing rod 900 inclined relative to the ground (referred to as an inclined rod), to facilitate the fixation of the parabolic antenna, the mounting base 700 may further include one or more third recesses, with an end of the third recess extending along an axial direction of the inclined rod. The clamp 800 may also be selectively positioned at any one of the third recesses, so that the mounting base 700 may be fixed on the inclined rod.

Referring to FIG. 19, the mounting base 700 may have a through hole 720, and the clamp 800 may be inserted into the through hole 720 to achieve detachable connection of the clamp 800 on the mounting base 700.

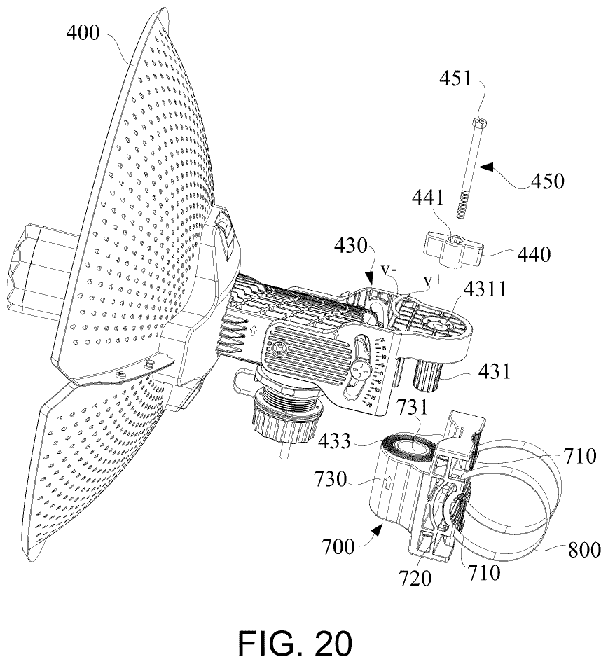

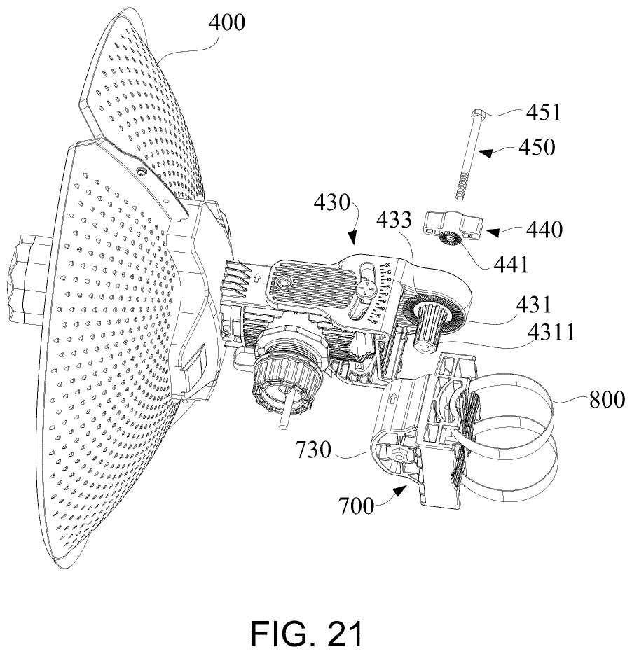

Referring to FIG. 20 and FIG. 21, the parabolic antenna further includes a connection base 430. The connection base 430 is mounted on the first reflector 400 and located between the first reflector 400 and the mounting base 700. The connection base 430 has a connection shaft 431. The mounting base 700 has a sleeve portion 730. The sleeve portion 730 is sleeved on a circumferential outer side of the connection shaft 431 and connected to the connection shaft 431. The connection shaft 431 is rotatably disposed relative to the sleeve portion 730. In this way, when the connection shaft 431 rotates relative to the sleeve portion 730, an angle of the connection base 430 relative to the mounting base 700 may be adjusted, thereby adjusting a horizontal installation angle of the communication device during installation to facilitate alignment of the communication device during construction.

For example, the sleeve portion 730 may be a sleeve shaft. The sleeve portion 730 has an assembly hole 731, and the connection shaft 431 is located within the assembly hole 731, so that the sleeve portion 730 is sleeved on the circumferential outer side of the connection shaft 431.

The connection base 430 is further equipped with a first connection member 450. The connection shaft 431 has a first connection hole 4311. The first connection member 450 may be inserted into the first connection hole 4311 and fixed to the sleeve portion 730 to achieve connection between the sleeve portion 730 and the connection shaft 431.

As a possible approach, the first connection member 450 may be screwed and fixed to the sleeve portion 730. An end of the first connection member 450 may have threads, and an end of the sleeve portion 730 may be screwed into a first locking member (not shown) to achieve fixation of the first connection member 450 on the sleeve portion 730. The first locking member may be a structural component such as a nut. The first locking member may be located outside the sleeve portion 730. Alternatively, the first locking member may also be integrated inside the sleeve portion 730.

Of course, the first connection member 450 may also be fixed to the sleeve portion 730 by other means, such as clamping. In the present application, the fixing method of the first connection member 450 on the sleeve portion 730 is not further limited.

Taking the example where the first connection member 450 is screwed and fixed to the sleeve portion 730, the structure of the communication device is further elaborated below.

Referring to FIG. 20 and FIG. 21, the connection base 430 is further provided with a first knob 440. The first knob 440 is located on a side of the connection base 430 away from the mounting base 700. The first knob 440 has a second connection hole 441 therein. The first connection member 450 may be sequentially inserted into the second connection hole 441 and the first connection hole 4311 and fixed to the sleeve portion 730. For example, the first connection member 450 may be fixed to the sleeve portion 730 by screwing. Through the first knob 440, the horizontal installation angle of the communication device may be adjusted.

Referring to FIG. 20, the first connection member 450 has a first connection head 451. The first connection head 451 may be a polygonal structure. The first connection hole 4311 is also a polygonal hole identical to the circumferential outer wall of the first connection head 451. The first connection head 451 is located within the first connection hole 4311. When the first knob 440 is rotated in a first direction, the first knob 440 drives the first connection head 451 to rotate simultaneously, so that the first connection member 450 may be fixed to the sleeve portion 730 by rotating the first knob 440. A second direction is opposite to the first direction. For example, the first direction may be referred to as the v+ direction, and the second direction may be referred to as the v-direction. When the first knob 440 is rotated in the second direction, the first knob 440 also drives the first connection head 451 to rotate simultaneously, so that the fixation of the first connection member 450 on the sleeve portion 730 may be released by rotating the first knob 440.

When it is necessary to adjust the horizontal installation angle of the communication device, the first knob 440 may be rotated in the second direction to release the fixation of the first connection member 450 on the sleeve portion 730, the connection base 430 may be rotated, and after adjusting the horizontal installation angle of the communication device, the first knob 440 may be rotated in the first direction to fix the first connection member 450 to the sleeve portion 730.

Referring to FIG. 20 and FIG. 21, the connection base 430 has engagement teeth 433 on a side provided with the connection shaft 431, and the sleeve portion 730 has engagement teeth 433 on a side facing the connection base 430. When the connection shaft 431 is assembled in the sleeve portion 730, the engagement teeth 433 on the connection base 430 engage with the engagement teeth 433 on the sleeve portion 730, increasing the friction between the connection base 430 and the sleeve portion 730 in the rotation direction of the connection shaft 431 during rotation of the connection base 430 relative to the sleeve portion 730, to ensure that the angle of the connection base 430 relative to the sleeve portion 730 remains fixed.

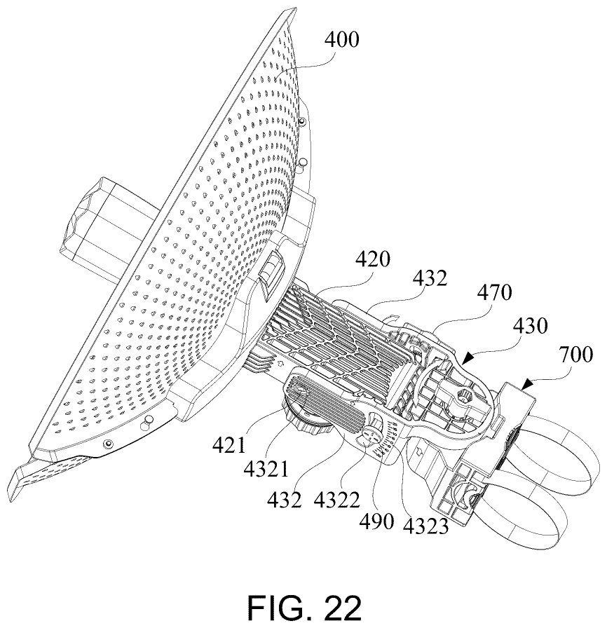

Referring to FIG. 22, the first reflector 400 has a fixing seat 420. The connection base 430 has a connection arm 432. The connection arm 432 may be integrally connected to the connection shaft 431. The connection arm 432 is disposed on a side of the fixing seat 420 and rotatably connected to the fixing seat 420. Through rotation of the fixing seat 420 relative to the connection arm 432, the pitch angle of the communication device during installation may be adjusted to facilitate alignment of the communication device during construction.

The number of connection arms 432 may be two. The two connection arms 432 are distributed on opposite sides of the fixing seat 420 and are both rotatably connected to the fixing seat 420. Each of the two connection arms 432 is provided with a third connection hole 4321. The fixing seat 420 is provided with a circular protrusion 421 at a position corresponding to each connection arm 432, and the circular protrusion 421 is assembled in the third connection hole 4321 on the corresponding connection arm 432 to achieve rotational connection between the connection arm 432 and the fixing seat 420. Through the provision of two connection arms 432, the stability of the connection between the connection base 430 and the fixing seat 420 may be enhanced, while also improving the stability of the rotation of the fixing seat 420 relative to the connection arms 432.

Taking the example of two connection arms 432, the structure of the communication device is further elaborated below.

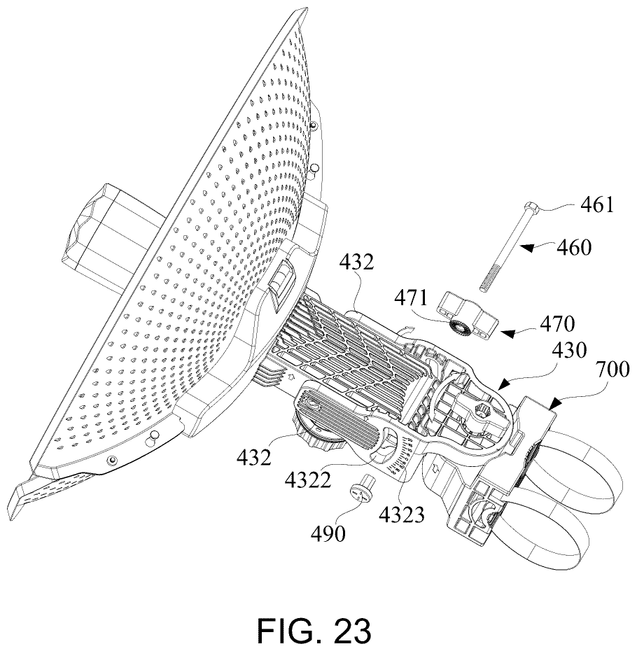

Referring to FIG. 23, the fixing seat 420 is further equipped with a second connection member 460. Each of the two connection arms 432 has a fourth connection hole 4322. The fourth connection hole 4322 is an arc-shaped hole. The fixing seat 420 has a fifth connection hole (not shown). The second connection member 460 may be inserted into the fifth connection hole and the two fourth connection holes 4322 and fixed to the connection arms 432 to achieve further connection between the connection base 430 and the fixing seat 420.

As a possible approach, the second connection member 460 may be screwed and fixed to the connection arms 432. An end of the second connection member 460 may have threads, and the end of the second connection member 460 may be screwed into a second locking member 490 to achieve fixation of the second connection member 460 on the connection arms 432. The second locking member 490 may be a structural component such as a nut. The second locking member 490 may be located outside the connection arms 432. Alternatively, the second locking member 490 may also be integrated inside the connection arms 432.

Of course, the second connection member 460 may also be fixed to the connection arms 432 by other means, such as clamping. In the present application, the fixing method of the second connection member 460 on the connection arms 432 is not further limited.

Taking the example where the second connection member 460 is screwed and fixed to the connection arms 432, the structure of the communication device is further elaborated below.

Referring to FIG. 22 and FIG. 23, the parabolic antenna further includes a second knob 470. The second knob 470 is located on a side of the connection base 430 away from the fixing seat 420. The second knob 470 has a sixth connection hole 471. The second connection member 460 may be inserted into the sixth connection hole 471, the fifth connection hole, and the two fourth connection holes 4322 and fixed to the connection arms 432. For example, the second connection member 460 may be fixed to the connection arms 432 by screwing. By rotating the second knob 470, the pitch angle of the communication device during installation may be adjusted to facilitate alignment of the communication device during construction.

Referring to FIG. 23, the second connection member 460 has a second connection head 461. The second connection head 461 may be a polygonal structure. The sixth connection hole 471 is also a polygonal hole identical to the circumferential outer wall of the second connection head 461. The second connection head 461 is located within the sixth connection hole 471. By rotating the second knob 470 in two opposite directions, the second connection member 460 may be fixed to the connection arms 432 or the fixation of the second connection member 460 on the connection arms 432 may be released, with specific details referring to the description above regarding the first knob 440 and the first connection member 450, which are not repeated here.

It should be noted that when it is necessary to adjust the pitch angle of the communication device during installation, the second knob 470 may be rotated in one direction to rotate the fixing seat 420, and after adjusting the pitch angle of the communication device, the second knob 470 may be rotated in the other direction to fix the second connection member 460 to the connection arms 432.

Referring to FIG. 22, the connection arm 432 further has a scale 4323 for rotation angle on a side of the third connection hole 4321, so that by observing the position of the second connection member 460 on the scale 4323, the rotation angle of the fixing seat 420 relative to the connection base 430 may be directly obtained, facilitating better adjustment of the pitch angle of the communication device. For example, when the pitch angle of the communication device is 0°, the second connection member 460 is located at the mark of number 0 on the scale 4323; when an upward pitch angle of 5° is needed for the communication device, the fixing seat 420 may be rotated so that the second connection member 460 is located at the mark of number 5 on the scale 4323 on a side toward the ground from the 0 position.

In the description of the present application, it should be understood that terms such as “center,” “longitudinal,” “lateral,” “length,” “width,” “thickness,” “upper,” “lower,” “front,” “rear,” “left,” “right,” “vertical,” “horizontal,” “top,” “bottom,” “inner,” “outer,” “clockwise,” “counterclockwise,” “axial,” “radial,” and “circumferential” indicating orientation or positional relationships are based on the orientation or positional relationships shown in the drawings, solely for the convenience of describing the present application and simplifying the description, and do not indicate or imply that the referred device or element must have a specific orientation, be constructed, and operated in a specific orientation, and thus should not be construed as limiting the present application.

Furthermore, the terms “first” and “second” are used for descriptive purposes only and should not be understood as indicating or implying relative importance or implicitly indicating the number of technical features indicated. Thus, features defined with “first” or “second” may explicitly or implicitly include at least one such feature. In the description of the present application, “multiple” means at least two, such as two, three, and the like, unless explicitly specified otherwise.

In the present application, unless explicitly specified and limited otherwise, terms such as “install,” “connect,” “attach,” and “fix” should be understood broadly, for example, as fixed connections, detachable connections, or integral connections; mechanical connections or electrical connections; direct connections or indirect connections through intermediaries; or internal communication between two elements or interaction relationships between two elements, unless explicitly limited otherwise. For those of ordinary skill in the art, the specific meanings of the above terms in the present application may be understood based on specific circumstances.

In the present application, unless explicitly specified and limited otherwise, a first feature being “on” or “under” a second feature may mean direct contact between the first and second features, or indirect contact through an intermediary. Moreover, a first feature being “above,” “over,” or “on top of” a second feature may mean that the first feature is directly above or obliquely above the second feature, or simply that the first feature is at a higher horizontal level than the second feature. A first feature being “below,” “under,” or “beneath” a second feature may mean that the first feature is directly below or obliquely below the second feature, or simply that the first feature is at a lower horizontal level than the second feature.

In the description of this specification, descriptions with reference to terms such as “one embodiment,” “some embodiments,” “example,” “specific example,” or “some examples” mean that specific features, structures, materials, or characteristics described in connection with the embodiment or example are included in at least one embodiment or example of the present application. In this specification, schematic representations of the above terms do not necessarily refer to the same embodiment or example. Moreover, the described specific features, structures, materials, or characteristics may be combined in any suitable manner in any one or more embodiments or examples. Additionally, those skilled in the art may combine and integrate different embodiments or examples and features of different embodiments or examples described in this specification, provided they do not conflict with each other.

Although embodiments of the present application have been shown and described above, it should be understood that the above embodiments are exemplary and should not be construed as limiting the present application. Those of ordinary skill in the art may make changes, modifications, substitutions, and variations to the above embodiments within the scope of the present application.

What is claimed is:

1. A communication device comprising:
an antenna comprising a feed and a wiring board, the feed comprising a dipole unit and the dipole unit comprising a first dipole and a second dipole, wherein the second dipole is formed on a surface of the wiring board; and
a communication apparatus comprising a circuit board, the first dipole being formed on a surface of the circuit board; wherein the circuit board is provided with a first slot, the wiring board extends through at least a portion of the first slot and connected to the circuit board; and the first dipole and the second dipole are both electrically connected to the circuit board.

2. The communication device according to claim 1, wherein the wiring board has a long side and a short side, and when the wiring board extends through the first slot, the long side intersects with the surface of the circuit board and is connected to the circuit board and the short side is located at a side of the circuit board; and
the second dipole is disposed on a side of the wiring board adjacent to the long side.

3. The communication device according to claim 2, wherein the feed comprises orthogonal dual-polarized dipoles, the first dipole is a vertically polarized dipole of the orthogonal dual-polarized dipoles, and the second dipole is a horizontally polarized dipole of the orthogonal dual-polarized dipoles.

4. The communication device according to claim 3, wherein a length of the first slot is greater than a length of the short side, and a slot width of the first slot is greater than a thickness of the wiring board; and
the long side is disposed perpendicular to the surface of the circuit board, and the short side is disposed parallel to the surface of the circuit board.

5. The communication device according to claim 3, wherein the first dipole comprises two first radiating arms, the two first radiating arms being formed on two surfaces of the circuit board in a thickness direction; and
the second dipole comprises two second radiating arms, the two second radiating arms being formed on a same surface of the wiring board.

6. The communication device according to claim 5, wherein the first radiating arm comprises a fan-shaped microstrip, and in a direction in which the two first radiating arms extend away from each other, a width of the fan-shaped microstrip gradually increases; a direction of the width of the fan-shaped microstrip being parallel to the short side.

7. The communication device according to claim 6, wherein the two first radiating arms are centrally symmetric to each other, the two first radiating arms being distributed on two sides of the first slot; and/or, the two second radiating arms are centrally symmetric to each other, the two second radiating arms being disposed on two sides of the wiring board.

8. The communication device according to claim 5, wherein the feed further comprises first transmission lines and second transmission lines, each of the two first radiating arms corresponding to one first transmission line; and one of the two first radiating arms is electrically connected to a radio frequency port on the circuit board through the corresponding first transmission line, and the other is grounded through the corresponding first transmission line;
each of the two second radiating arms corresponds to one second transmission line; one of the two second radiating arms is electrically connected to the radio frequency port through the corresponding second transmission line, and the other is grounded through the corresponding second transmission line; and
both the first transmission line and the second transmission line are formed on the circuit board.

9. The communication device according to claim 8, wherein the feed further comprises a balun structure, the balun structure being located on the circuit board and electrically connected to the radio frequency port;
each of the two first radiating arms is electrically connected to the balun structure through one first transmission line to form radiation, and each of the two second radiating arms is electrically connected to the balun structure through one second transmission line to form radiation;
the balun structure is configured to achieve a 180°phase shift, so that currents in the two first radiating arms flow in a same direction, and currents in the two second radiating arms flow in a same direction;
the balun structure comprises a first microstrip balun and a second microstrip balun, the first microstrip balun being located on a surface of the circuit board provided with the radio frequency port, and the second microstrip balun being located on a surface of the circuit board opposite to the first microstrip balun and grounded;
one of the two first radiating arms is electrically connected to the first microstrip balun through the corresponding first transmission line, and the other is electrically connected to the second microstrip balun through the corresponding first transmission line; and
one of the two second radiating arms is electrically connected to the first microstrip balun through the corresponding second transmission line, and the other is electrically connected to the second microstrip balun through the corresponding second transmission line.

10. The communication device according to claim 1, wherein when the wiring board extends through at least a portion of the first slot, the wiring board intersects with the circuit board and is connected through a plurality of connection portions; the connection portions being distributed on a same surface of the circuit board;
the first slot is located in a middle region of the circuit board; and
a distance between the first slot and a top edge of the circuit board is greater than or equal to 3 mm and less than or equal to 10 mm.

11. The communication device according to claim 1, wherein the antenna comprises a parabolic antenna, the parabolic antenna further comprising a first reflector, a reflective surface of the first reflector being a paraboloid, and the circuit board being located within a reflection region of the reflective surface.

12. The communication device according to claim 11, wherein the first dipole and the second dipole are spaced apart along a line connecting a focus of the paraboloid and a center of the paraboloid, the second dipole being located below the first dipole.

13. The communication device according to claim 12, wherein the first dipole is located at the focus of the paraboloid; and
a distance between the first dipole and the second dipole along the line is greater than or equal to one-ninth of a wavelength of a center frequency of the parabolic antenna and less than or equal to one-sixth of the wavelength of the center frequency of the parabolic antenna.

14. The communication device according to claim 13, wherein a direction of the length of the first slot is parallel to the line and a short side of the wiring board and the wiring board is provided with a second slot on a side where the second dipole is disposed, the second dipole being disposed adjacent to a slot opening side of the second slot; and
when the wiring board extends through the first slot, a portion of the wiring board is inserted into the first slot and rests on a slot wall of the first slot, the second slot being located below the first slot.

15. The communication device according to claim 14, further comprising a microstrip parasitic unit, where the microstrip parasitic unit is located on a side of the dipole unit away from the communication apparatus and configured to enhance a gain of the second dipole.

16. The communication device according to claim 15, wherein the microstrip parasitic unit comprises a first microstrip unit and a second microstrip unit, each of the first microstrip unit and the second microstrip unit comprising two microstrips;
the two microstrips of the first microstrip unit are symmetrically disposed on the circuit board, and the two microstrips of the second microstrip unit are symmetrically disposed on the wiring board; and
when at least a portion of the wiring board is inserted into the first slot, the two microstrips of the first microstrip unit are connected to the two microstrips of the second microstrip unit to form the microstrip parasitic unit.

17. The communication device according to claim 16, wherein a distance between a microstrip of the microstrip parasitic unit and the second radiating arm is one-quarter of a wavelength of a center frequency of the parabolic antenna.

18. The communication device according to claim 11, wherein the antenna further comprises a second reflector, the second reflector being mounted on an end of the circuit board away from the first reflector, the second reflector covering the dipole unit.

19. The communication device according to claim 11, further comprising a housing, wherein the circuit board is located within the housing; and/or
the first reflector has a plurality of through holes, the through holes being distributed on the reflective surface of the first reflector.

20. The communication device according to claim 11, wherein the parabolic antenna further comprises a mounting base and a clamp, the mounting base being mounted on a side of the first reflector away from the feed;
the mounting base has two intersecting recesses, shapes of the two recesses being adapted to a shape of a circumferential outer wall of a fixing rod, with an end of the recess in a length direction extending to a side wall of the mounting base and forming a notch on the side wall of the mounting base; the length direction of the recess is parallel to a length direction of the fixed fixing rod;
the clamp is detachably mounted on the mounting base, and is selectively positioned at either of the two recesses to secure the mounting base to the fixing rod;
the parabolic antenna further comprises a connection base, the connection base being mounted on the first reflector and located between the first reflector and the mounting base; and the connection base having a connection shaft;
the mounting base has a sleeve portion, the sleeve portion being sleeved on a circumferential outer side of the connection shaft and connected to the connection shaft; and the connection shaft being rotatably disposed relative to the sleeve portion; and
the first reflector has a fixing seat, the connection base having a connection arm and the connection arm being disposed on a side of the fixing seat and rotatably connected to the fixing seat.
